(19) United States
(12) Patent Application Publication
(10) Pub. No.: US 2020/0126052 A1
(43) Pub. Date: Apr. 23, 2020

(54) TRANSFERS USING CREDIT ACCOUNTS

(71) Applicant: AMERICAN EXPRESS TRAVEL RELATED SERVICES COMPANY, INC., New York, NY (US)

(72) Inventors: Manish Deliwala, Chandler, AZ (US); Patrick L. Dostal, Scottsdale, AZ (US); Anil Dua, Phoenix, AZ (US); Adam Krochak, New York, NY (US); Mukund Shankar Simha Raghu, Glendale, AZ (US); Vignesh Veeraiyan, Phoenix, AZ (US)

(21) Appl. No.: 16/655,343

(22) Filed: Oct. 17, 2019

Related U.S. Application Data
(60) Provisional application No. 62/746,866, filed on Oct. 17, 2018.

(51) Int. Cl. G06Q 20/10; G06Q 20/22; G06Q 20/40; G06Q 20/32; G06Q 20/24; G06F 3/0482; H04W 8/18

(52) U.S. Cl. CPC G06Q 20/108; G06Q 20/227; G06Q 20/40; H04W 8/18; G06Q 20/24; G06F 3/0482; G06Q 20/3255

(57) ABSTRACT

Disclosed are various embodiments for transfers using credit accounts. A request to send a specified amount of funds from a specified credit account to a recipient is received from a first client device. A transaction identifier for the request to send the specified amount of funds to the recipient is requested from the computing device. A first notification is sent to a second client device, wherein the first notification comprises the transaction identifier and the second client device is associated with the recipient. A second notification is received from the second client device that the recipient has accepted the specified amount of funds. A funds transfer is then initiated to the monetary account for the specified amount of funds.

### CROSS-REFERENCE TO RELATED APPLICATIONS

This application claims priority to, and the benefit of, U.S. Provisional Patent Application No. 62/746,866, entitled PEER-TO-PEER INTERBANK TRANSFERS USING CREDIT ACCOUNTS and filed on Oct. 17, 2018, which is incorporated by reference as if set forth herein in its entirety.

### BACKGROUND

Many individuals have credit card accounts to pay for items or services. When a credit card holder makes a payment, he or she provides his or her information to a merchant. The merchant, in turn, submits the credit card information to a credit card transaction network, which routes the transaction information to the issuing bank of the credit card holder. The issuing bank can debit or charge the respective credit card for the transaction and then provide payment to the network who in turn provides payment to the bank of the merchant. However, while a credit card holder is able to make a payment to any merchant with access to the credit card transaction network, a payer is unable to pay other credit card holders or non-merchants with his or her credit card. Similarly, while a merchant is able to receive funds from any customer, a merchant is unable to pay other merchants or customers except in the instance of refunding a specific transaction. Moreover, use of credit card transaction networks are often associated with higher fees relative to other payment rails.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1R are pictorial diagrams of examples of user interfaces rendered by a client according to various embodiments of the present disclosure.

FIG. 2 is a drawing of a network environment according to various embodiments of the present disclosure.

FIGS. 3-5 are sequence diagrams illustrating examples of functionality implemented as portions of an application executed in a computing environment in the network environment of FIG. 2 according to various embodiments of the present disclosure.

FIGS. 6A and 6B are sequence diagrams illustrating examples of functionality implemented as portions of an application executed in a computing environment in the network environment of FIG. 2 according to various embodiments of the present disclosure.

FIGS. 7A and 7B are sequence diagrams illustrating examples of functionality implemented as portions of an application executed in a computing environment in the network environment of FIG. 2 according to various embodiments of the present disclosure.

FIGS. 8 and 9 are sequence diagrams illustrating examples of functionality implemented as portions of an application executed in a computing environment in the network environment of FIG. 2 according to various embodiments of the present disclosure.

### DETAILED DESCRIPTION

Disclosed are various approaches for using credit accounts, such as credit cards, to send and receive funds. A funds transfer, such as a transfer through an automated clearinghouse (ACH) network or a real-time gross settlement (RTGS) network can be used to transfer funds between financial institutions. A financial institution can include any institution or entity that stores funds on behalf of a customer in an account and allows a customer to have funds deposited into the account or have funds transferred from the account. Accordingly, a financial institution could include a bank, credit union, a savings and loan, a broker, a brokerage houses, a money transmitter, a payment provider that offers stored-value accounts, etc.

Before or after the transfer is completed, a credit or debit can be made to a credit card account to reflect the nature of the transfer of funds. Accordingly, a credit account (e.g., a credit card) can be used to pay funds to any individual with a monetary account (e.g., checking account, savings account, brokerage account, stored-value account, etc.) or credit account. Likewise, a credit account can also receive funds from any individual with a monetary or credit account. As a result, a credit card can be used to receive funds from or pay funds through any arbitrary payment platform or payment network, which are sometimes referred to as payment rails. In the following discussion, a general description of the system and its components is provided, followed by a discussion of the operation of the same.

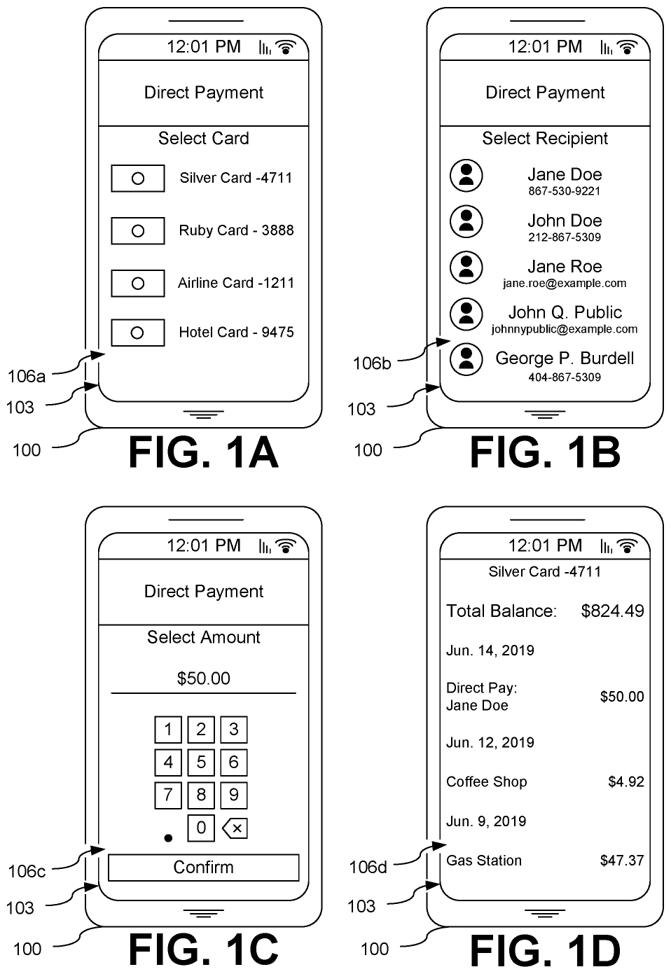

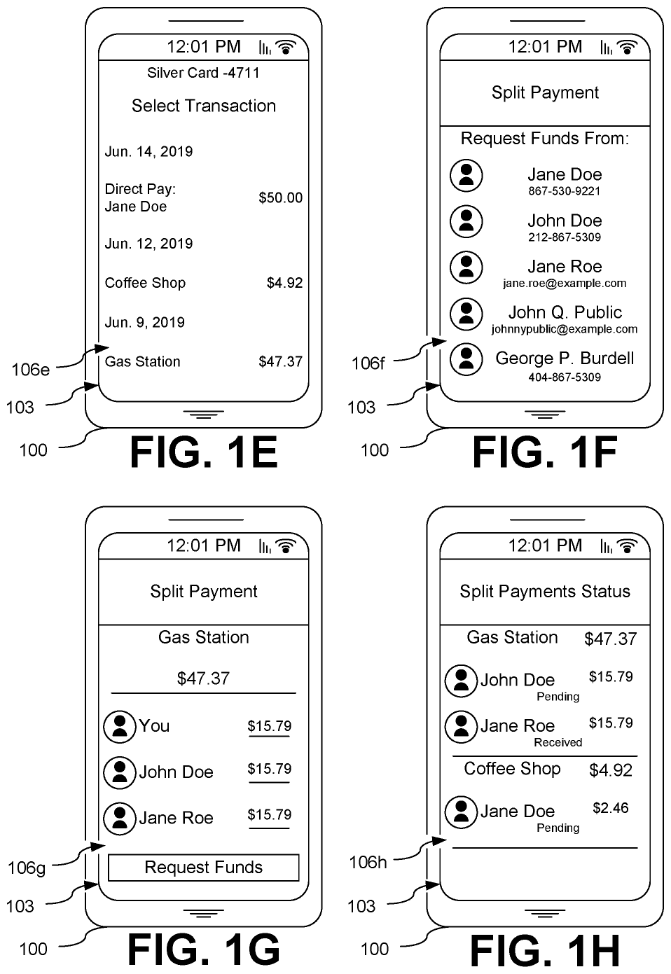

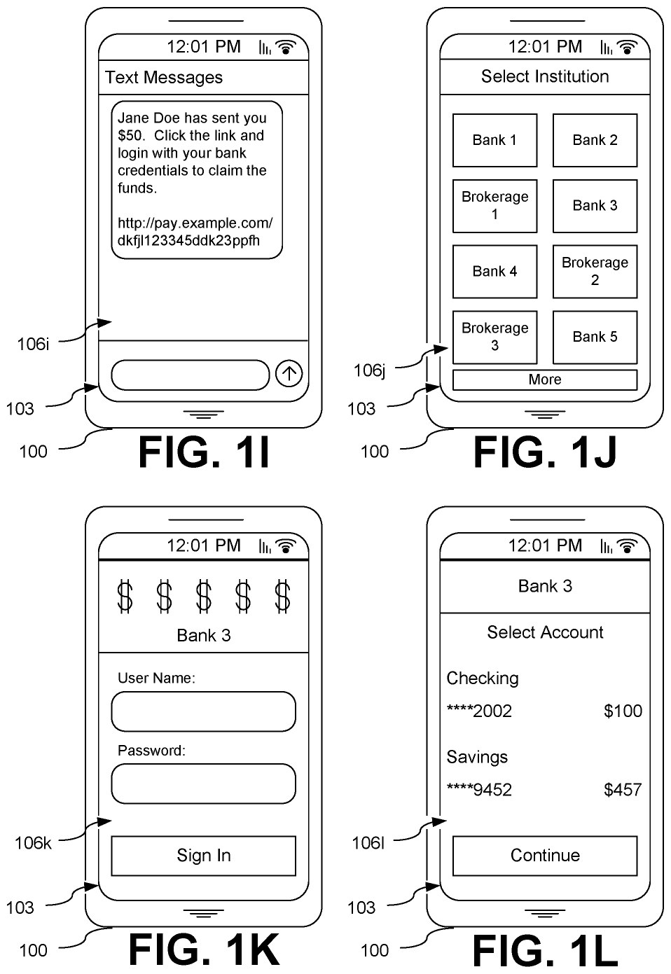

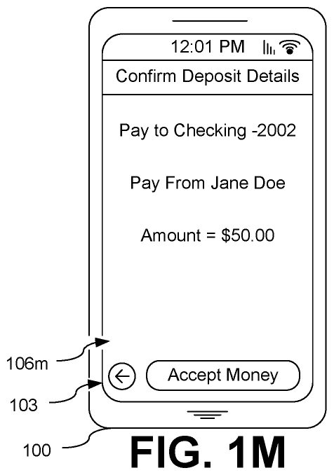

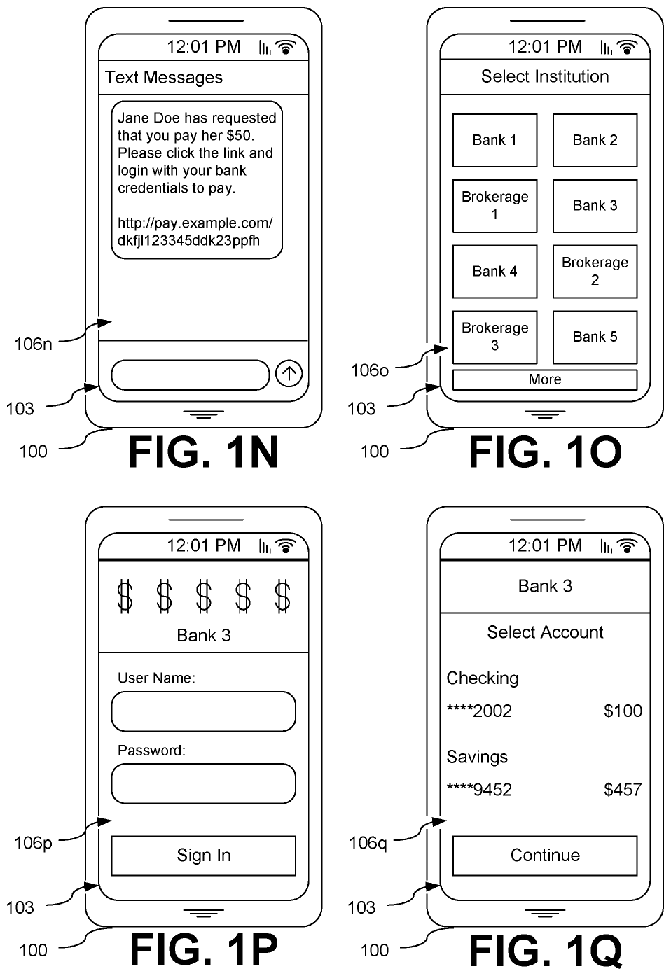

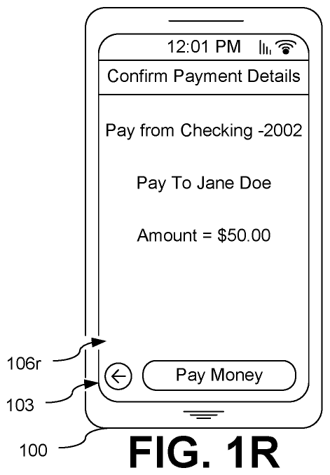

FIGS. 1A-1D illustrate examples of how a payer might interact with a client device 100 to send money to a third-party (e.g., a friend, coworker, client, or merchant) using a credit card account. However, a payer could interact with his or her client device 100 in other manners to send money to a third-party using a credit card account in other implementations.

FIG. 1A depicts a client device 100 with a display 103 according to various embodiments of the present disclosure. A user interface 106a can be rendered on the display 103 of the client device 100. As illustrated, a payer can select a credit card from a list of credit cards presented within the user interface 106a for direct payment to another individual. For example, if a payer had logged into his or her mobile banking application on the client device 100 and selected an option to directly pay another individual, he or she could be presented with an interface such as the user interface 106a.

FIG. 1B depicts a client device 100 with a display 103 according to various embodiments of the present disclosure. A user interface 106b can be rendered on the display 103 of the client device 100. As illustrated, a payer can select a recipient of the funds from a list of recipients presented in the user interface 106b. For individual recipients in the list of recipients, a unique identifier associated with the recipient could be presented. Such unique identifiers could represent contact information of a recipient, such a mobile phone number, an email address, etc. For instance, if a recipient has been previously paid using his or her phone number as a unique identifier, then the recipient's phone number might be presented. Where multiple unique identifiers map to the same recipient, a default identifier could be presented.

The list of recipients could be populated using various approaches or combinations of approaches. For example, the list of recipients in the user interface 106b could be populated from an address book or list of contacts accessible to the client device 100. In such a situation, if an entry in an address book or contact list matched a known recipient, then the entry could be added to the list of recipients. As another example, recipients could have been manually added by a user.

FIG. 1C depicts a client device 100 with a display 103 according to various embodiments of the present disclosure. A user interface 106c can be rendered on the display 103 of the client device 100. As illustrated, a payer can specify an amount of money to pay to the recipient selected using the user interface 106b. After the payer has specified the amount of money, the payer could then confirm the amount of money to be paid through the user interface 106c. In a subsequent user interface 106, the payer could confirm the transaction details (e.g., selected credit card, selected recipient, and specified amount of funds) and initiate payment to the recipient using the credit card account of the user.

FIG. 1D depicts a client device 100 with a display 103 according to various embodiments of the present disclosure. A user interface 106d can be rendered on the display 103 of the client device 100. As illustrated, a payer could view his or her account balance and prior transactions within the user interface 106d. Examples of prior transactions could include credit card transactions with a merchant or direct payments to other individuals, such as a recipient selected using the user interface 106b. The amount of the transaction could also be displayed next to each prior transaction.

FIGS. 1E-1H illustrate examples of how a recipient could split a transaction between multiple individuals and request payment from each individual for his or her share. Although FIGS. 1E-1H illustrate an example of how a recipient could request payment, other similar approaches are also encompassed by various embodiments of the present disclosure. For instance, instead of splitting a particular or an entire transaction, a recipient could specify another amount to be split between multiple individuals and request payment from each individual for his or her share of the total. As another example, a recipient could specify an amount of money to request for payment from a single individual.

FIG. 1E depicts a client device 100 with a display 103 according to various embodiments of the present disclosure. A user interface 106e can be rendered on the display 103 of the client device 100. As illustrated, the user interface 106e can include a list of transactions that the user can select. For example, if a recipient wished to split the cost of a particular purchase (e.g., a meal at a restaurant, a tank of gasoline for a car, a gift from a store, etc.), the recipient could select the purchase from the transactions presented in the user interface 106e.

FIG. 1F depicts a client device 100 with a display 103 according to various embodiments of the present disclosure. A user interface 106f can be rendered on the display 103 of the client device 100. As illustrated, the user interface 106f can include a list of individuals with whom the transaction selected in user interface 106e should be split. For individual payers in the list of payers, a unique identifier associated with the payer could be presented. Such unique identifiers could represent contact information of a payer, such a mobile phone number, an email address, etc. For instance, if a payer has been previously paid using his or her phone number as a unique identifier, then the payer's phone number might be presented. Where multiple unique identifiers map to the same payer, a default identifier could be presented.

The list of payers could be populated using various approaches or combinations of approaches. For example, the list of payers in the user interface 106f could be populated from an address book or list of contacts accessible to the client device 100. In such a situation, if an entry in an address book or contact list matched a known payer, then the entry could be added to the list of payers. As another example, payers could have been manually added by a user.

FIG. 1G depicts a client device 100 with a display 103 according to various embodiments of the present disclosure. A user interface 106g can be rendered on the display 103 of the client device 100. As illustrated, the user interface 106g can allow a recipient to specify how to split the cost of a transaction selected from user interface 106e among the payers selected from user interface 106f. In some instances, an initial split of the transaction may be presented (e.g., an equal split between the individuals). However, the amount to be requested from any one individual may be adjusted within the user interface 106g. Once an amount has been decided, a recipient can interact with the user interface to request the funds from the individual payers.

FIG. 1H depicts a client device 100 with a display 103 according to various embodiments of the present disclosure. A user interface 106h can be rendered on the display 103 of the client device 100 to allow the recipient to see the status of payments that have been requested, for example as depicted in FIGS. 1E-G. As illustrated, one or more pending payments can be presented to the recipient within the user interface 106h. For example, after a recipient has requested funds from one or more individuals for a particular transaction through user interface 106g, the recipient may be able to view which payers have or have not paid or which payers have a payment pending by viewing the list of pending payments within the user interface 106h.

FIGS. 1I-1M illustrate examples of how a user could claim or receive funds paid to him or her from a credit card account of another. For example, if a recipient received a payment of funds as a result of a workflow illustrated in FIGS. 1A-1H, then a recipient might interact with one or more user interfaces 106 as depicted in one or more FIGS. 1I-1M.

FIG. 1I depicts a client device 100 with a display 103 according to various embodiments of the present disclosure. A user interface 106i can be rendered on the display 103 of the client device 100. As illustrated, a recipient has received a message indicating that funds have been sent to the recipient and are available. To claim the funds, the recipient could select the link.

FIG. 1J depicts a client device 100 with a display 103 according to various embodiments of the present disclosure. A user interface 106j can be rendered on the display 103 of the client device 100. As illustrated, the recipient may have selected the link previously presented in user interface 106i and is presented with a user interface 106j that allows a recipient to select a financial institution from a plurality of financial institutions. The recipient could select the financial institution where he or she has an account in which he or she would wish to deposit the funds that he or she will receive.

FIG. 1K depicts a client device 100 with a display 103 according to various embodiments of the present disclosure. A user interface 106k can be rendered on the display 103 of the client device 100. As illustrated, the recipient is presented with an authentication interface to authenticate with a previously selected financial institution. For example, the recipient may have previously selected the financial institution from the list provided in user interface 106j.

FIG. 1L depicts a client device 100 with a display 103 according to various embodiments of the present disclosure. A user interface 106l can be rendered on the display 103 of the client device 100. As illustrated, the user interface 106l can provide a recipient with a list of accounts and account balances within the selected financial institution. The recipient may be presented with the user interface 106l in response to a successful authentication using the user interface 106k. Within the user interface 106l, the recipient may be able to select one of the accounts in which he or she wishes to deposit the funds.

FIG. 1M depicts a client device 100 with a display 103 according to various embodiments of the present disclosure. A user interface 106m can be rendered on the display 103 of the client device 100. As illustrated, the user interface 106m provides for a confirmation step to allow a recipient to review the transaction. This can include, for example, the amount of money that will be deposited, the account into which the funds will be deposited, and the individual who is paying the funds. Once the information is reviewed, the recipient may be able to confirm the transaction and accept the funds using the user interface 106m. The funds can then be deposited in the recipient's account, as discussed later.

In some alternative implementations, however, the recipient might not be prompted to authenticate with his or her financial institution. For example, the recipient could be prompted, after selecting his or her financial institution in FIG. 1J, to enter his or her account number. In these scenarios, the funds could be automatically deposited after the recipient provides his or her account information and confirms the deposit, as illustrated in FIG. 1M

FIGS. 1N-1R illustrate examples of how a user could consent to a request to pay funds to the credit card account of another. For example, if a payer received a request to pay funds as a result of a workflow illustrated in FIGS. 1E-1H, then a payer might interact with one or more user interfaces 106 as depicted in one or more FIGS. 1N-1R.

FIG. 1N depicts a client device 100 with a display 103 according to various embodiments of the present disclosure. A user interface 106N can be rendered on the display 103 of the client device 100. As illustrated, a payer has received a message indicating another individual is requesting payment. To consent to the payment request, the payer could select the link.

FIG. 1O depicts a client device 100 with a display 103 according to various embodiments of the present disclosure. A user interface 106o can be rendered on the display 103 of the client device 100. As illustrated, the payer may have selected the link previously presented in user interface 106n and is presented with a user interface 106o that allows a payer to select a financial institution from a plurality of financial institutions. The payer could select the financial institution where he or she has an account from which he or she would wish to have funds withdrawn to honor the payment request.

FIG. 1P depicts a client device 100 with a display 103 according to various embodiments of the present disclosure. A user interface 106p can be rendered on the display 103 of the client device 100. As illustrated, the payer is presented with an authentication interface to authenticate with a previously selected financial institution. For example, the payer may have previously selected the financial institution from the list provided in user interface 106o.

FIG. 1Q depicts a client device 100 with a display 103 according to various embodiments of the present disclosure. A user interface 106q can be rendered on the display 103 of the client device 100. As illustrated, the user interface 106q can provide a payer with a list of accounts and account balances within the selected financial institution. The payer may be presented with the user interface 106l in response to a successful authentication using the user interface 106p. Within the user interface 106q, the payer may be able to select one of the accounts in which he or she wishes to have funds withdrawn to honor the payment request.

FIG. 1R depicts a client device 100 with a display 103 according to various embodiments of the present disclosure. A user interface 106r can be rendered on the display 103 of the client device 100. As illustrated, the user interface 106r provides for a confirmation step to allow a payer to review the transaction. This can include, for example, the amount of money that will be withdrawn, the account from which the funds will be withdrawn, and the individual to whom the funds will be paid. Once the information is reviewed, the payer may be able to confirm the transaction and accept the funds using the user interface 106r. The funds can then be deposited in the recipient's account, as discussed later.

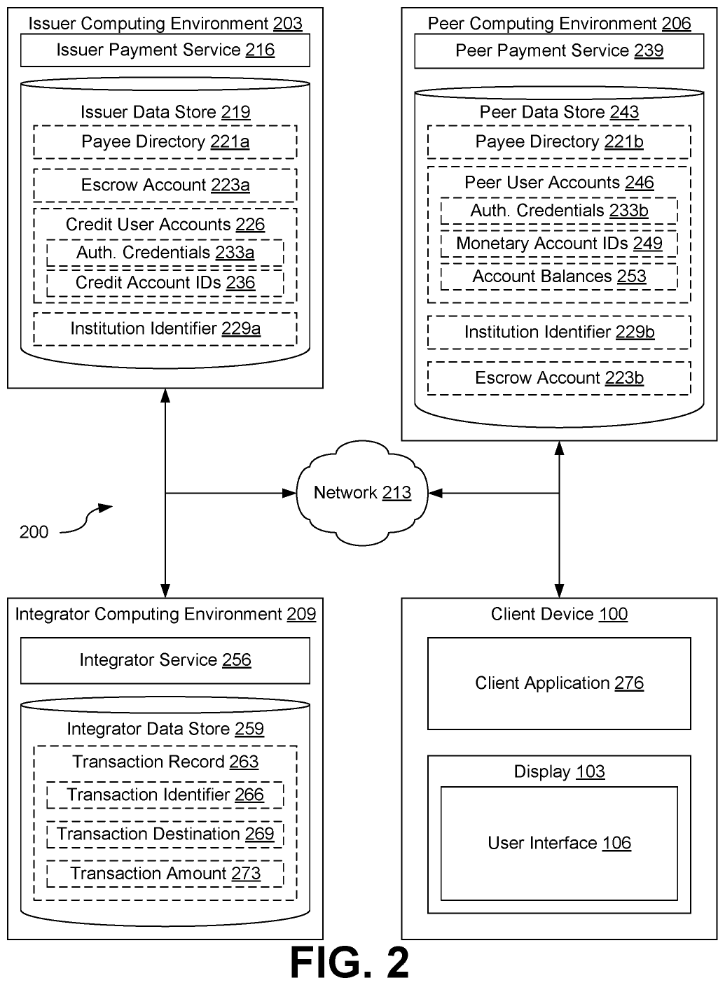

With reference to FIG. 2, shown is a network environment 200 according to various embodiments. The network environment 200 can include an issuer computing environment 203, a peer computing environment 206, an integrator computing environment 209, and a client device 100. The issuer computing environment 203 can be operated by or on behalf of a credit card issuer—a financial institution that issues credit on behalf of customers in the form of credit card accounts. The peer computing environment 206 can be operated by or on behalf of a peer financial institution—a financial institution with customers that a holder of a credit card account with the credit card issuer wishes to send payment to or receive payment from. The integrator computing environment 209 can be operated on behalf of a financial services integrator—an institution that provides a common set of protocols, tools, or an application programming interface to allow customers with different banks to integrate their accounts at different institutions into a single application or service. The issuer computing environment 203, the peer computing environment 206, the integrator computing environment 209, and the client device 100 can be in data communication with each other via a network 213.

The network 213 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 213 can also include a combination of two or more networks 213. Examples of networks 213 can include the Internet, intranets, extranets, virtual private networks (VPNs), and similar networks.

The issuer computing environment 203, peer computing environment 206, and the integrator computing environment 209 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, issuer computing environment 203, peer computing environment 206, and the integrator computing environment 209 can employ a plurality of computing devices that can be arranged in one or more server banks or computer banks or other arrangements. Such computing devices can be located in a single installation or can be distributed among many different geographical locations. For example, the issuer computing environment 203, peer computing environment 206, or the integrator computing environment 209 can include a plurality of computing devices that together can include a hosted computing resource, a grid computing resource or any other distributed computing arrangement. In some cases, the issuer computing environment 203, peer computing environment 206, or the integrator computing environment 209 can correspond to an elastic computing resource where the allotted capacity of processing, network, storage, or other computing-related resources can vary over time.

Various applications or other functionality can be executed in the issuer computing environment 203 according to various embodiments. The components executed on the issuer computing environment 203 can include an issuer payment service 216, as well as other applications, services, processes, systems, engines, or functionality not discussed in detail herein.

The issuer payment service 216 can be executed to process funds transfers on behalf of a customer with a credit card account with the issuer. For example, the issuer payment service 216 could process payment of funds from a customer's credit card account to a merchant or customer with a financial account at another financial institution. As another example, the issuer payment service 216 could receive funds on behalf of a customer with a credit card account with the issuer and credit the funds to the credit card account balance of the customer.

Also, various data is stored in an issuer data store 219 that is accessible to the issuer computing environment 203. The issuer data store 219 can be representative of a plurality of data stores, which can include relational databases, object-oriented databases, hierarchical databases, hash tables or similar key-value data stores, as well as other data storage applications or data structures. The data stored in the issuer data store 219 is associated with the operation of the various applications or functional entities described below. This data can include a payee directory 221a an escrow account 223a, one or more credit user accounts 226, an institution identifier 229a, and potentially other data.

A payee directory 221, such as the payee directory 221a, can represent a directory of payees or recipients of funds. For example, for any unique identifier for an individual, such as a phone number, email account, etc., a record could be stored in the payee directory 221a that identifies the institution identifier 229 and/or credit account identifier 236 or monetary account identifier 249 that were used in the prior transaction. As a result, subsequent payments to the same payee can be expedited by the issuer payment service 216 referencing the payee directory 221a to determine where to direct funds.

An escrow account 223, such as the escrow account 223a, can represent a financial account operated by the credit card issuer for the temporary storage of funds transferred between credit card accounts and other financial accounts. For example, when a credit card holder receives funds from a financial account of a customer at a peer financial institution, the funds could be deposited in the escrow account 223a. A credit could then be applied to the credit card account of a customer.

The use of the escrow account 223a can allow for credit card accounts to participate in interbank transaction networks other than credit card networks operated by credit card associations (e.g., VISA®, MASTERCARD®, DISCOVER®, DINER CLUB®, CHINA UNIONPAY®, or INDIAN RUPAY®). For example, a credit card issuer could initiate a transfer from the escrow account 223a to an account at another financial institution on behalf of a credit card account holder. The credit card issuer could then charge the credit card account for the amount of funds transferred. Likewise, the credit card issuer could charge the credit card first and then initiate the transfer. As a result, a credit card account holder could pay funds to another party using his or her credit card without having to use a credit card network. Similarly, the credit card issuer could receive a deposit to the escrow account 223a on behalf of a credit card account holder and subsequently credit the funds to the balance of the credit card account, or vice versa. As a result, a credit card account holder could accept payments from others and have those payments deposited or credited to his or her credit card account.

The credit user accounts 226 can represent the account information of customers of an issuer who operates the issuer computing environment 203. For example, each customer who has at least one credit card account, charge card account, or similar direct-debit credit account may have a credit user account 226 with the issuer. Accordingly, a credit user account 226 can include one or more authentication credentials 233a and one or more credit account identifiers 236. Additional information about a customer can also be stored in a credit user account 226, such as his or her name, contact information (e.g., mailing address, phone number(s), or email address), etc.

Authentication credentials 233, such as authentication credentials 233a, can include any items of data that can be used to authenticate or verify the identity of a holder of an account. Examples of authentication credentials 233 can include usernames, passwords, personal identification numbers (PINs), one-time passwords (OTPs), authentication tokens, cryptographic key pairs or certificates, etc. Depending on the level of security desired, a user may be required to provide one or more authentication credentials 233 to prove his or her identity (e.g., two-factor authentication, multi-factor authentication, etc.).

A credit account identifier 236 can be any unique identifier that identifies a credit account (e.g., a credit card account, a charge card account, etc.) held by a customer with an issuer. Examples of credit account identifiers 236 can include payment card numbers, such as credit or charge card numbers, or account numbers created by the issuer that uniquely identify individual accounts maintained by the issuer with respect to other accounts. When a customer has multiple credit accounts with an issuer, a customer can have multiple credit account identifiers 236 associated with his or her credit user account 226. For example, a customer might have a first credit account identifier 236 for a charge card account provided by the issuer and a second credit account identifier 236 for a credit card account provided by the issuer.

The institution identifier 229, such as the institution identifier 229a, can represent any unique identifier that allows for transfers of funds to be identified as originating from or destined for a financial institution. Accordingly, each financial institution can have an institution identifier 229 associated with it. Examples of institution identifiers 229 include American Bankers Association (ABA) routing transit numbers (RTNs), Society for Worldwide Interbank Financial Telecommunication (SWIFT) business identifier codes (BICs), or similar identifiers. Where a financial institution participates in multiple transaction or payment networks, a financial institution can have multiple institution identifiers 229. For example, a bank in the United States may have both an ABA RTN and a SWIFT BIC.

In some instances, the institution identifier 229a can also be embedded in or a component of a credit account identifier 236. For example, the first few digits of a credit or charge card number often act as an Issuer Identification Number (IIN) that uniquely identifies the issuer of a credit or charge card account.

Various applications or other functionality can be executed in the peer computing environment 206 according to various embodiments. The components executed on the peer computing environment 206 can include a peer payment service 239, as well as other applications, services, processes, systems, engines, or functionality not discussed in detail herein.

The peer payment service 239 can be executed to process funds transfers on behalf of a customer with a monetary account with the peer institution. For instance, the peer payment service 239 could receive a funds transfer through an interbank payment network that identified a monetary account as the destination and credit the funds to the monetary account maintained by the peer institution. As another example, the peer payment service 239 could initiate a funds transfer through the interbank payment network to an account at the same or another institution and debit the funds from the monetary account maintained by the peer institution. Monetary accounts maintained by the peer institution can include any account from which deposits and/or withdrawals are permitted to be made on demand. Examples of monetary accounts can include transaction accounts (e.g., checking accounts, current accounts, demand deposit accounts, etc.), savings accounts, money-market accounts, brokerage accounts, stored-value accounts, etc.

Also, various data is stored in a peer data store 243 that is accessible to the peer computing environment 206. The peer data store 243 can be representative of a plurality of data stores, which can include relational databases, object-oriented databases, hierarchical databases, hash tables or similar key-value data stores, as well as other data storage applications or data structures. The data stored in the peer data store 243 is associated with the operation of the various applications or functional entities described below. This data can include a payee directory 221b, an escrow account 223b, one or more peer user accounts 246, an institution identifier 229b for the peer institution, and potentially other data.

A peer user account 246 can represent the account information of customers of a peer financial institution who operates the peer computing environment 206. For example, each customer who has at least one monetary account with the peer financial institution can have a peer user account 246. Accordingly, a peer user account 246 can include one or more authentication credentials 233b and one or more monetary account identifiers 249. Information about each monetary account, such as an account balance 253 (e.g., the value of funds currently in the account), may also be stored in association with a peer user account 246. Additional information about a customer can also be stored, such as his or name, contact information (e.g., mailing address, phone number(s), or email address), etc.

A monetary account identifier 249 is a unique identifier for any monetary account maintained by the peer financial institution. These could include account numbers internally created by the peer financial institution, international bank account numbers (IBANs), or similar identifiers for differentiating between individual monetary accounts.

Various applications or other functionality can be executed in the integrator computing environment 209 according to various embodiments. The components executed on the integrator computing environment 209 include an integrator service 256, and other applications, services, processes, systems, engines, or functionality not discussed in detail herein.

The integrator service 256 can be executed to integrate or otherwise connect credit or monetary accounts maintained by an issuer or peer financial institution with an application or with other institutions. For example, an integrator service 256 could provide a web page, portal, or application that allows a user to authenticate with an issuer payment service 216 or a peer payment service 239. After authentication occurs, the integrator service 256 could retrieve information from a credit user account 226 or a peer user account 246 (e.g., account numbers and institution identifiers 229) and relay it to another service, application, or institution authorized by the user.

Although depicted separately and independently from the issuer payment service 216 and the peer payment service 239, the integrator service 256 can be operated by the same entity as or in conjunction with either the peer payment service 239 or the issuer payment service 216. In these implementations, some of the functionality previously described as being performed by either the issuer payment service 216 or the peer payment service 239 could be performed by the integrator service 256. Likewise in these implementations, functions described as being performed by the integrator service 256 could be performed by either the issuer payment service 216 or the peer payment service 239.

Also, various data is stored in an integrator data store 259 that is accessible to the integrator computing environment 209. The integrator data store 259 can be representative of a plurality of data stores, which can include relational databases, object-oriented databases, hierarchical databases, hash tables or similar key-value data stores, as well as other data storage applications or data structures. The data stored in the integrator data store 259 is associated with the operation of the various applications or functional entities described below. This data can include one or more transaction records 263, and potentially other data.

Although depicted separately and independently from the issuer data store 219 and the peer data store 243, the integrator data store 259 can be operated by the same entity as or in conjunction with either the issuer data store 219 and the peer data store 243. In these implementations, data store in the integrator data store 259 could be stored in either the issuer data store 219 or the peer data store 243. Likewise, data stored in the issuer data store 219 or the peer data store 243 could be stored in the integrator data store 259.

A transaction record 263 can represent any financial transaction facilitated by the integrator service 256. This could include, for example, a transfer of funds between two financial accounts maintained by two different financial institutions. Accordingly, a transaction record 263 can include a transaction identifier 266, a transaction destination 269, and/or a transaction amount 273. Additional information, such as the source of a transaction, may also be stored in a transaction record 263 in some embodiments. However, other embodiments may not include additional information or limit the amount of additional information collected to minimize privacy risks to customers in the event of a data breach.

The transaction identifier 266 can include any identifier that can be used to differentiate between individual transaction records 263. Examples of transaction identifiers 266 can include sequential numbers assigned to transactions as they are created, hashes of the transaction record 263, etc.

The transaction destination 269 represents the account and financial institution where funds in a transaction are deposited. Accordingly, the transaction destination 269 can include both an institution identifier 229 and an account identifier (e.g., a credit account identifier 236 or a monetary account identifier 249).

The transaction amount 273 can represent the total amount of funds involved in the transaction or transfer. In some implementations, the transaction amount 273 may represent the amount of funds transferred from one account to another. In other implementations, additional fees or charges (e.g., processing fees or interchange fees) may also be included in the transaction amount 273.

The client device 100 is representative of a plurality of client devices 100 that can be coupled to the network 213. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 can include one or more displays 103, such as liquid crystal displays (LCDs), gas plasma-based flat panel displays, organic light emitting diode (OLED) displays, electrophoretic ink (“E-ink”) displays, projectors, or other types of display devices. In some instances, the display 103 can be a component of the client device 100 or can be connected to the client device 100 through a wired or wireless connection.

The client device 100 can be configured to execute various applications such as a client application 276 or other applications. The client application 276 can be executed in a client device 100 to access network content served up by the issuer computing environment 203, the peer computing environment 206, the integrator computing environment 209, or other servers, thereby rendering a user interface 106 on the display 103. To this end, the client application 276 can include a browser, a dedicated application, or other executable, and the user interface 106 can include a network page, an application screen, or other user mechanism for obtaining user input. The client device 100 can be configured to execute applications beyond the client application 276 such as email applications, social networking applications, word processors, spreadsheets, or other applications.

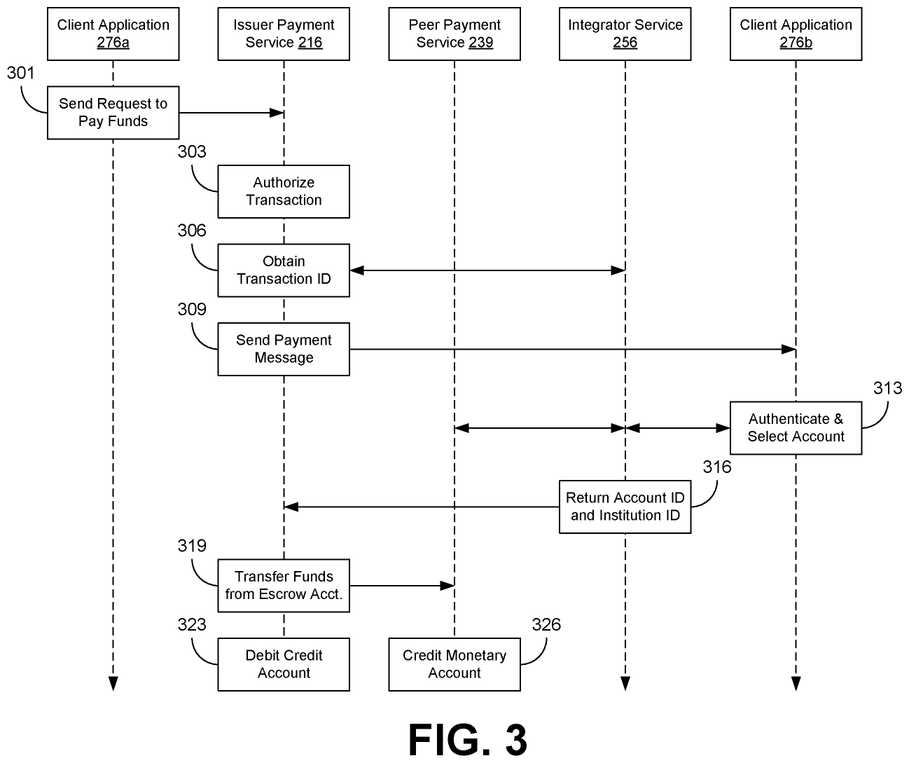

Next, a general description of the operation of the various components of the network environment 200 is provided. Although an example of the interaction between the various components of the network environment 200 is provided in the following paragraphs, other interactions and operations are possible. A more detailed description of the various interactions between the components of the network environment 200 is provided in the subsequent discussion of FIGS. 3-8.

To begin, a payer could use a client application 276 executing on his or her client device 100 to send a request to the issuer payment service 216. The request could specify contact information for a recipient, an amount of money to pay the recipient, and the credit or charge account to use for paying the recipient. Accordingly, the request could include a cellular phone number or email address for the recipient, a transaction amount 273, and a credit account identifier 236.

The issuer payment service 216 could then send a request to the integrator service 256 for a transaction identifier 266. In response, the integrator service 256 could create a transaction record 263 that includes the transaction identifier 266. The integrator service 256 could then return the transaction identifier 266 to the issuer payment service 216.

Next, the issuer payment service 216 could send a message to a client device 100 of the recipient. For example, the issuer payment service 216 could send a short message service (SMS) message or e-mail to the contact information for the recipient that was provided by the payer. The message could include a notification that the payer is sending funds to the recipient. The message could also include the transaction identifier 266 and a link to a web page or interface provided by the integrator service 256. If the recipient wishes to claim the funds, the recipient could click, select, or otherwise follow the link.

Once the recipient follows the link, the integrator service 256 could provide a web page or similar user interface 106 to the recipient. Within the user interface 106, the recipient could select his or her financial institution from a list of supported financial institutions. The recipient could then provide his or her authentication credentials 233b for his or her peer user account 246 with the selected financial institution. The integrator service 256 could then authenticate with the selected financial institution on behalf of the recipient and retrieve a list of monetary account identifiers 249. The integrator service 256 could then update the user interface 106 to prompt the recipient to select a monetary account identifier 249 for the monetary account in which the recipient wishes to receive funds.

Once the recipient has selected a monetary account identifier 249, the integrator service 256 can provide the monetary account identifier 249 and an institution identifier 229b to the issuer payment service 216. The integrator service 256 could also provide the transaction identifier 266 in order to assist the issuer payment service 216 in identifying which individual transaction from a plurality of transactions that the monetary account identifier 249 and the institution identifier 229b are associated with.

Upon receipt of the monetary account identifier 249 and the institution identifier 229b, the issuer payment service 216 could initiate a transfer using an interbank transaction network to place funds into the account of the recipient. For some types of transfers, funds could be transferred from the escrow account 223a to the account of the recipient. In other types of transfers, funds could be transferred between escrow accounts 223a and 223b. The issuer payment service 216 could then reduce a credit limit assigned to the credit account of the payer. In some implementations, the credit limit could be reduced immediately or nearly immediately from the credit account of the payer. In other implementations, the credit limit could be reduced once the issuer payment service 216 receives an indication or confirmation that the transfer has completed. There can also be implementations where the credit limit could be reduced prior to the transfer occurring. Such implementations could allow for the effect of an immediate transfer of funds, even if the transfer of the funds is not settled between institutions until later.

Similarly, a recipient could use a client application 276 executing on his or her client device 100 to send a request to the issuer payment service 216 for another individual to pay the recipient. The request could specify contact information for a recipient, an amount of money that the recipient is requesting for the payer to pay the recipient, and the credit account identifier 236 of the credit account of the recipient into which funds should be deposited. Accordingly, the request could include a cellular phone number or email address for the recipient, a transaction amount 273, and a credit account identifier 236 of the recipient.

The issuer payment service 216 could then send a request to the integrator service 256 for a transaction identifier 266. In response, the integrator service 256 could create a transaction record 263 that includes the transaction identifier 266. The integrator service 256 could then return the transaction identifier 266 to the issuer payment service 216.

Next, the issuer payment service 216 could send a message to a client device 100 of the payer. For example, the issuer payment service 216 could send a short message service (SMS) message or e-mail to the contact information for the payer that was provided by the recipient. The message could include a notification that the recipient is requesting funds from the payer. The message could also include the transaction identifier 266 and a link to a web page or interface provided by the integrator service 256. If the payer wishes to send the requested funds, the payer could click, select, or otherwise follow the link.

Once the payer follows the link, the integrator service 256 could provide a web page or similar user interface 106 to the payer. Within the user interface 106, the payer could select his or her financial institution from a list of supported financial institutions. The payer could then provide his or her authentication credentials 233b for his or her peer user account 246 with the selected financial institution. The integrator service 256 could then authenticate with the selected financial institution on behalf of the payer and retrieve a list of monetary account identifiers 249. The integrator service 256 could then update the user interface 106 to prompt the payer to select a monetary account identifier 249 for the monetary account from which the payer wishes to send the requested funds to the recipient. Once the payer has selected a monetary account identifier 249, the integrator service 256 can send the monetary account identifier 249 and institution identifier 229b for the peer institution to the issuer payment service 216. The integrator service 256 could also provide the transaction identifier 266 in order to assist the issuer payment service 216 in identifying with which individual transaction from a plurality of transactions that the monetary account identifier 249 and the institution identifier 229b are associated.

Upon receipt of the monetary account identifier 249 and the institution identifier 229b, the issuer payment service 216 could send a request to the peer payment service 239 to initiate a transfer of funds. The request could include the institution identifier 229a associated with the issuer payment service 216 and an account number or identifier for the escrow account 223a. The request could also include the transaction identifier 266 associated with the transfer or the monetary account identifier 249 from which funds would be paid.

In response, the peer payment service 239 could initiate an institutional funds transfer from the account of the payer or from the escrow account 223b to the escrow account 223a. Once the issuer payment service 216 confirms receipt of the funds, a credit could be applied to the credit account of the recipient identified by the credit account identifier 236. However, in some implementations, the credit could be applied to the credit account prior to the initiation of the institutional funds transfer. This could allow for a recipient or a payer to experience an immediate or real-time funds transfer, even if the transfer of the funds is not settled between institutions until later.

Many types of transfers could be used by the issuer payment service 216 or peer payment service 239 in any of these examples. For instance, real time gross settlement (RTGS) systems could be used to provide for an immediate transfer of funds. Examples of RTGS systems include wire transfer systems such as Fedwire. However, batch processed, net settlement systems could be used where the transfer of funds is not time sensitive. Examples of batch processed, net settlement systems include automated clearing house (ACH) networks, such as FedACH or the Electronic Payments Network (EPN).

Referring next to FIG. 3, shown is a sequence diagram that provides one example of the operation of the interactions between the various components of the network environment 200 to transfer funds between a credit card issuer and a peer financial institution. It is understood that the sequence diagram of FIG. 3 provides merely an example of the many different types of functional arrangements that can be employed to implement a transfer of funds within the network environment 200. As an alternative, the sequence diagram of FIG. 3 can be viewed as depicting an example of elements of a method implemented within the network environment 200.

Beginning with box 301, the client application 276a can send a request to the issuer payment service 216 to pay funds to a recipient. The request can include the credit account identifier 236 from which funds are to be paid, the amount of funds to be paid, the identity of and contact information (e.g., phone number or email address) for the recipient, and potentially other information.

Moving on to box 303, the issuer payment service 216 can authorize the transaction. For example, the issuer payment service 216 could evaluate whether a credit limit associated with the credit account identifier 236 has a sufficient amount of credit to permit a payment of the funds to the recipient. If the issuer payment service 216 fails to authorize the transaction, the sequence of interactions may stop.

Then at box 306, the issuer payment service 216 can send a request to the integrator service 256 for a transaction identifier 266. In response, the integrator service 256 can generate and provide the transaction identifier 266 to the issuer payment service 216. The issuer payment service 216 may store the transaction identifier 266 temporarily in order to allow the issuer payment service 216 to later determine or map the request to pay funds from the credit account of the payer, as identified by the credit account identifier 236, to a monetary account maintained by a peer financial service.

Next at box 309, the issuer payment service 216 can send a payment request message to the recipient. For example, if the payer had provided a mobile phone number for the recipient at box 301, then the issuer payment service 216 could send a short message service (SMS) message to the client device 100 of the recipient. As another example, if the payer had provided an email address for the recipient at box 303, then the issuer payment service 216 could send an email to the email address for the recipient.

However, in some implementations, the functionality of box 309 could be performed by the integrator service 256. For example, after creating a transaction identifier 266, the integrator service 256 could send the payment request message to the recipient. In these implementations, the issuer payment service 216 would have provided the integrator service 256 with the relevant contact information (e.g., phone number or email address) at box 306.

The payment request message can include a number of items. For example, the payment request message could include a uniform resource indicator (URI) that includes an address for the integrator service 256 and the transaction identifier 266. The payment request message could further include a message or indication that the payer is sending funds to the recipient, the amount of the funds, the identity of the payer, etc.

Subsequently at box 313, the client application 276b can authenticate the recipient and obtain from the recipient an identification or selection of a monetary account identifier 249 into which the funds will be deposited. For example, when the recipient selects the link included in the payment request message, the client device 100 could open the client application 276b and direct the client application 276b to send a request to the integrator service 256. The request could include the transaction identifier 266 included in the URI that was previously sent at box 309.

The integrator service 256 could then provide a response to the client application 276b to prompt the recipient to identify his or her financial institution. This response could, for example, cause the client application 276b to render a user interface 106 to allow a recipient to select the financial institution. After the recipient selects the financial institution, the integrator service 256 could then prompt the client application 276b to obtain authentication credentials 233b from the recipient.

After the recipient supplies the authentication credentials 233b to the integrator service 256, the integrator service 256 could authenticate with the peer payment service 239 on behalf of the recipient. Once authenticated, the integrator service 256 could then request a list of monetary account identifiers 249 from the peer payment service 239 that are associated with the recipient. The integrator service 256 could then provide the list of monetary account identifiers 249 (e.g., account numbers for a checking account, a savings account, etc.) to the client application 276b for the recipient to select an account to which the funds from the payer are to be deposited. Once the recipient selects a monetary account identifier 249, the client application 276b can provide it to the integrator service 256. For example, if the recipient selected his or her checking account from within the client application 276b, the client application 276b could provide the monetary account identifier 249 to the integrator service 256 as the selected account.

Next at box 316, the integrator service 256 could provide the selected monetary account identifier 249 to the issuer payment service 216 and the institution identifier 229b for the peer financial institution that maintains the account identified by the monetary account identifier 249. For example, if the recipient had, at box 313, authenticated with ExampleBank and selected his or her checking account at ExampleBank as the account into which the funds should be deposited, then the integrator service 256 could provide the ABA routing number of ExampleBank and the checking account number of the recipient at ExampleBank. The integrator service 256 could also return the transaction identifier 266 at box 316 to allow the issuer payment service 216 to determine which payment the monetary account identifier 249 and the institution identifier 229b should be associated with.

Then at box 319, the issuer payment service 216 can initiate a transfer of funds from the escrow account 223a to the monetary account of the recipient or to the escrow account 223b of the peer financial institution. For example, the issuer payment service 216 could initiate an ACH payment from the escrow account 223a and designate the monetary account at the peer financial institution of the recipient, as identified by the monetary account identifier 249 and the institution identifier 229b provided at box 316a. As another example, the issuer payment service 216 could initiate a wire transfer payment from the escrow account 223a and designates the monetary account at the peer financial institution of the recipient. However, the issuer payment service 216 can use any batch processed, net settlement or real time gross settlement payment system to transfer funds.

Subsequently at box 323, the issuer payment service 216 can deduct from available amount of credit in the credit account of the payer an amount equal to the amount of funds transferred from the escrow account 223a to the monetary account of the recipient maintained by the peer financial institution. This can create a liability of the payer to the issuer for the amount of funds transferred on behalf of the issuer. As a result, the payer is able to cause a payment from his or her credit account (e.g., credit card) to be made to another party (e.g., another individual) without having to use a credit card transaction network. Meanwhile, at box 326 the peer payment service 239 can credit or otherwise deposit the funds received from the issuer into the monetary account of the recipient. It should be noted that the functionality depicted at boxes 323 and 326 could be implemented earlier in the sequence diagram. For example, the respective credits and debits could occur prior to the transfer of funds at box 319 of the transfer of account information at box 316.

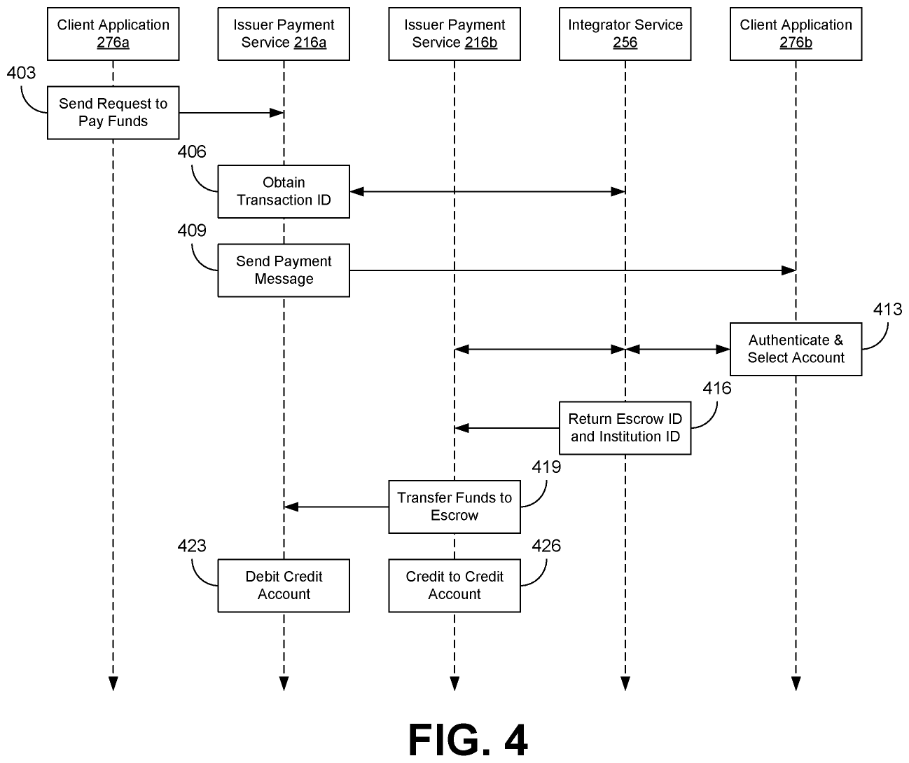

Referring next to FIG. 4, shown is a sequence diagram that provides one example of the operation of the interactions between the various components of the network environment 200 to transfer funds between a first credit issuer and a second credit issuer (e.g., credit card issuers). It is understood that the sequence diagram of FIG. 4 provides merely an example of the many different types of functional arrangements that can be employed to implement a transfer of funds within the network environment 200. As an alternative, the sequence diagram of FIG. 4 can be viewed as depicting an example of elements of a method implemented within the network environment 200.

Beginning with box 403, which is similar to box 303, the client application 276a can send a request to the issuer payment service 216a to pay funds to a recipient. The request can include the credit account identifier 236 from which funds are to be paid, the amount of funds to be paid, the identity of and contact information (e.g., phone number or email address) for the recipient, and potentially other information.

At box 406, which is similar to box 306, the issuer payment service 216a can send a request to the integrator service 256 for a transaction identifier 266. In response, the integrator service 256 can generate and provide the transaction identifier 266 to the issuer payment service 216a. The issuer payment service 216a may store the transaction identifier 266 temporarily in order to allow the issuer payment service 216a to later determine or map the request to pay funds from the credit account of the payer, as identified by the credit account identifier 236, to a credit account maintained by another issuer.

Next at box 409, which is similar to box 309, the issuer payment service 216a sends a payment request message to the recipient. For example, if the payer had provided a mobile phone number for the recipient at box 403, then the issuer payment service 216a could send a short message service (SMS) message to the client device 100 of the recipient. As another example, if the payer had provided an email address for the recipient at box 403, then the issuer payment service 216a could send an email to the email address for the recipient.

However, in some implementations, the functionality of box 409 could be performed by the integrator service 256. For example, after creating a transaction identifier 266, the integrator service 256 could send the payment request message to the recipient. In these implementations, the issuer payment service 216 would have provided the integrator service 256 with the relevant contact information (e.g., phone number or email address) at box 406.

Then at box 413, which is similar to box 313, the client application 276b can authenticate the recipient and obtain from the recipient an identification or selection of a credit account identifier 236 to which the funds will be credited. For example, when the recipient selects the link included in the payment request message, the client device 100 could open the client application 276b and direct the client application 276b to send a request to the integrator service 256. The request could include the transaction identifier 266 included in the URI that was previously sent at box 409.

The integrator service 256 could then provide a response to the client application 276b to prompt the recipient to identify his or her financial institution, such as the issuer of his or her credit account (e.g., credit card). This response could, for example, cause the client application 276b to render a user interface 106 to allow a recipient to select the financial institution. After the recipient selects the financial institution, the integrator service 256 could then prompt the client application 276b to obtain authentication credentials 233a from the recipient.

After the recipient supplies the authentication credentials 233a to the integrator service 256, the integrator service 256 could authenticate with the issuer payment service 216b on behalf of the recipient. Once authenticated, the integrator service 256 could then request a list of credit account identifiers 236 from the issuer payment service 216b that are associated with the recipient. The integrator service 256 could then provide the list of credit account identifiers 236 (e.g., account numbers for a checking account, a savings account, etc.) to the client application 276b for the recipient to select an account to which the funds from the payer are to be credited. Once the recipient selects a credit account identifier 236, the client application 276b can provide it to the integrator service 256, which could relay the selected credit account identifier 236 to the issuer payment service 216b. For example, if the recipient selected a particular credit card account from within the client application 276b, the client application 276b could provide the respective credit card number to the integrator service 256 as the selected account. The integrator service 256 could then provide this credit card number to the issuer payment service 216b for future reconciliation of the transaction between the payer and the recipient.

At box 416, which is similar to box 316, the integrator service 256 could provide the selected credit account identifier 236 to the issuer payment service 216a and the institution identifier 229a for the recipient's financial institution that maintains the account identified by the credit account identifier 236. For example, if the recipient had, at box 413, authenticated with ExampleBank and selected his or her credit card account at ExampleBank as the account into which the funds should be credited, then the integrator service 256 could provide the ABA routing number of ExampleBank and the number of the escrow account 223a maintained by ExampleBank. The integrator service 256 could also return the transaction identifier 266 at box 416 to allow the issuer payment service 216a to determine which payment the account number of the escrow account 223a and the institution identifier 229a should be associated with.

Next at box 419, which is similar to box 319, the issuer payment service 216a can initiate a transfer of funds from the escrow account 223a of the payer's credit issuer to the escrow account 223a of the recipient's credit issuer. While an issuer payment service 216 is illustrated previously in FIG. 2 as having an escrow account 223a, where two separate issuer payment services 216a and 216b are exchanging funds, each issuer payment service 216 is understood to have a separate escrow account 223a. For example, the issuer payment service 216a could initiate an ACH payment between the escrow accounts 223a. As another example, the issuer payment service 216a could initiate a wire transfer payment between the escrow account 223a and the account for the recipient. However, the issuer payment service 216a can use any batch processed, net settlement or real time gross settlement payment system to transfer funds. Likewise, at box 421, the issuer payment service 216b for the recipient's credit issuer can receive the funds in its respective escrow account 223a.

Then at box 423, which is similar to box 323, the issuer payment service 216a can deduct from available amount of credit in the credit account of the payer an amount equal to the amount of funds transferred between the escrow accounts 223a. This can create a liability of the payer to his or her issuer for the amount of funds transferred on behalf of the issuer. As a result, the payer is able to cause a payment from his or her credit account (e.g., credit card) to be made to the credit account of another party (e.g., another individual) without having to use a credit card transaction network. It should be noted that the functionality depicted at boxes 423 and 426 could be implemented earlier in the sequence diagram. For example, the respective credits and debits could occur prior to the transfer of funds at box 419 of the transfer of account information at box 416.

Meanwhile at box 426, which is similar to box 326, the issuer payment service 216b can credit the funds received from the issuer payment service 216a to the credit account of the recipient. The funds received in the escrow account 223a at box 421 would therefore count as a payment or credit towards the outstanding balance of the recipient on his or her credit account. As a result, the recipient is able to use his or her credit account (e.g., a credit card) as a transaction account that is able to receive deposits from third-parties and make payments to third parties.

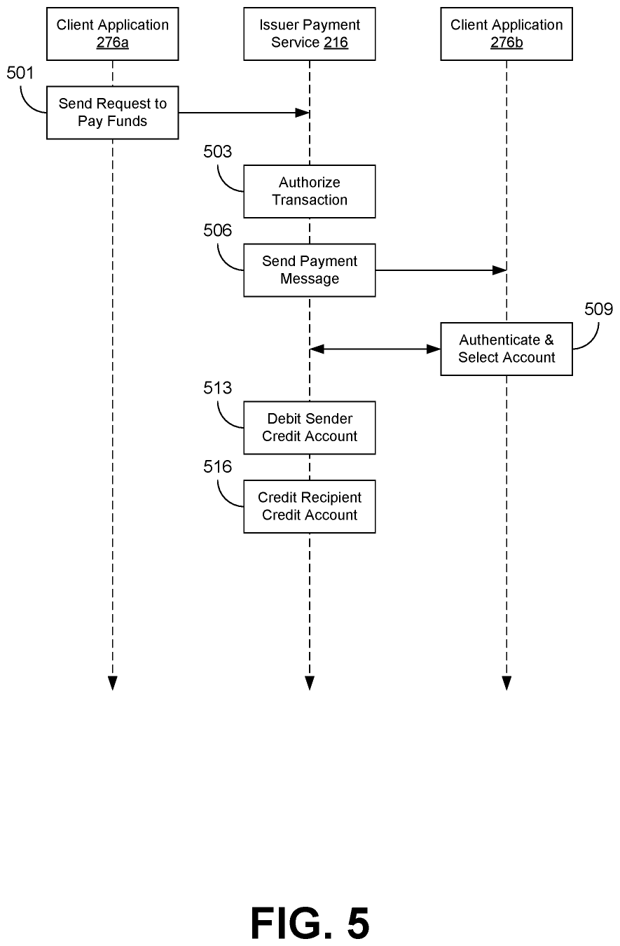

Referring next to FIG. 5, shown is a sequence diagram that provides one example of the operation of the interactions between the various components of the network environment 200 to transfer funds between credit accounts (e.g., credit cards) issued by the same institution. It is understood that the sequence diagram of FIG. 5 provides merely an example of the many different types of functional arrangements that can be employed to implement a transfer of funds within the network environment 200. As an alternative, the sequence diagram of FIG. 5 can be viewed as depicting an example of elements of a method implemented within the network environment 200.

Beginning with box 501, the client application 276a can send a request to the issuer payment service 216 to pay funds to a recipient. The request can include the credit account identifier 236 from which funds are to be paid, the amount of funds to be paid, and the identity of the recipient. As both the payer and recipient maintain accounts with the same issuer in this example, the issuer payment service 216 may already have the contact information for the recipient. However, if the payer is aware of the recipient's preferred contact information (e.g., preferred phone number or email address), it may be included in the request as well.

Proceeding to box 503, the issuer payment service 216 can authorize the transaction. For example, the issuer payment service 216 could evaluate whether a credit limit associated with the credit account identifier 236 has a sufficient amount of credit to permit a payment of the funds to the recipient. If the issuer payment service 216 fails to authorize the transaction, the sequence of interactions may stop.

Next at box 506, the issuer payment service 216 can send a payment request message to the recipient. For example, if the payer had provided a mobile phone number for the recipient at box 501, then the issuer payment service 216 could send a short message service (SMS) message to the client device 100 of the recipient. As another example, if the payer had provided an email address for the recipient at box 501, then the issuer payment service 216 could send an email to the email address for the recipient. The message could include, for example a link to an authentication page provided by the issuer payment service 216.

Then at box 509, the client application 276b can authenticate with the issuer payment service 216. For example, the recipient could input authentication credentials 233a into a user interface 106 of the client application 276b, which the client application 276b could use to authenticate the recipient with the issuer payment service 216. In response to authentication, the issuer payment service 216 could provide the client application 276b with one or more credit account identifiers 236 that the recipient could select (e.g., credit card account numbers of credit card accounts held by the recipient with the issuer). The credit account identifiers 236 could then be presented to the recipient in a user interface 106 by the client application 276b, who could select an account for receiving funds from the payer. The selected credit account identifier 236 could then be provided to the issuer payment service 216.

In some implementations, however, boxes 506 and/or 509 may be optional. For example, if the recipient has been previously paid by the payer or another party, information such as the credit account identifier 236 for a credit account of the recipient may already be stored in the payee directory 221a. As another example, if the recipient has previously created an account with the issuer payment service 216, the recipient's information may also already be stored in the payee directory 221a. In such instances, payment to the recipient could proceed directly from box 503 to boxes 513 and 516 using the information stored in the payee directory 221a.

In boxes 513 and 516, the account balances of the credit accounts of the payer and receiver could be adjusted to reflect the transaction. For example, at step 513, the credit account of the payer could be debited by the issuer payment service 216 to reflect the payment of funds. Likewise, at step 516, the credit account of the recipient could be credited by a respective amount of funds to reflect the payment. As a result, two credit account holders are able to pay funds to or receive funds from any other credit account holder at the same institution without having to use a credit card transaction network.

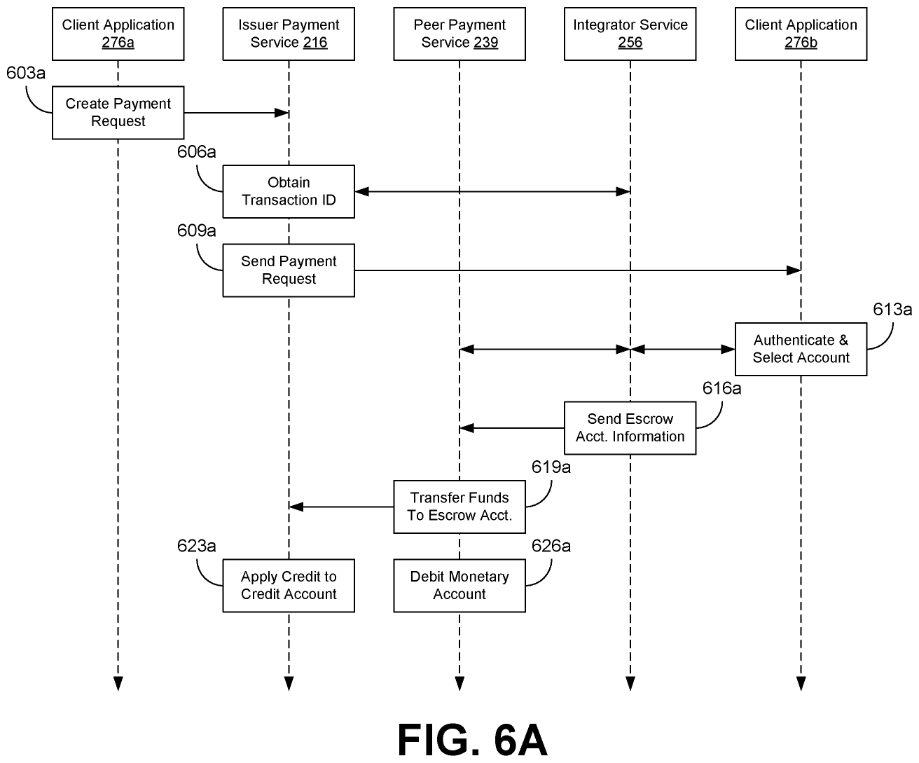

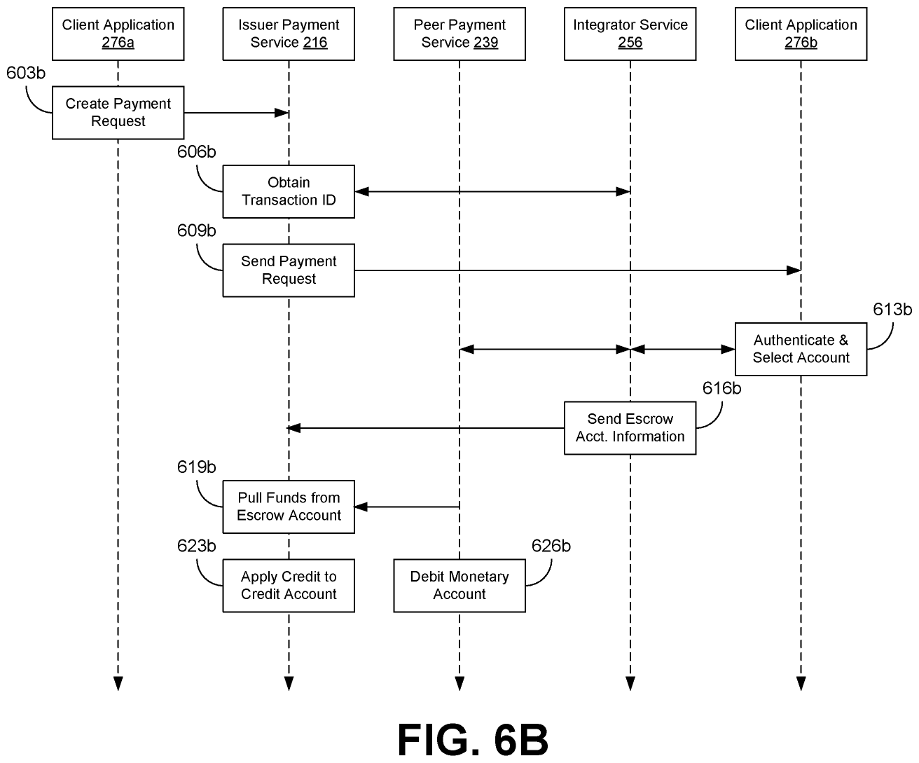

Referring next to FIG. 6A, shown is a sequence diagram that provides one example of the operation of the interactions between the various components of the network environment 200 to request that one party pay funds from a monetary account to the credit account of another party. It is understood that the sequence diagram of FIG. 6A provides merely an example of the many different types of functional arrangements that can be employed to implement a transfer of funds within the network environment 200. As an alternative, the sequence diagram of FIG. 6A can be viewed as depicting an example of elements of a method implemented within the network environment 200.

Beginning with box 603a, a payment request can be created by the client application 276a and forwarded to the issuer payment service 216. The payment request could be created by a recipient interacting with a user interface 106 rendered by the client application 276a. For instance, a credit account holder (e.g., a credit card holder) could create a request that a monetary account holder (e.g., a bank or brokerage account holder) at a peer financial institution pay the credit account holder a specified sum of funds, which could be applied as a credit to the outstanding balance of the respective credit account. The request could include the amount of funds requested, the identity of the payer, and the contact information of the payer. Once complete, the payment request can be forwarded on to the issuer payment service 216.

In some implementations, multiple payment requests could be created at box 603a. For example, a recipient could select a transaction displayed within a user interface 106 of the client application 276a and indicate that he or she wishes to split the transaction between multiple individuals. This could occur, for example, if the recipient made a purchase on behalf of a group of individuals and wished to be reimbursed. In this example, the cost of the transaction could be split between individuals, as indicated by the recipient, and a respective payment request could be created for each individual payer that owed funds to the recipient.

Then at box 606a, the issuer payment service 216 can send a request to the integrator service 256 for a transaction identifier 266. In response, the integrator service 256 can generate and provide the transaction identifier 266 to the issuer payment service 216. The issuer payment service 216 may store the transaction identifier 266 temporarily in order to allow the issuer payment service 216 to later determine or map the request to pay funds from the credit account of the payer, as identified by a respective monetary account identifier 249, to a credit account maintained by the recipient. In some instances, the issuer payment service 216 can provide the integrator service 256 with the account number for the escrow account 223a associated with the issuer payment service 216.

Moving on to box 609a, the issuer payment service 216 can send a payment request message to the requested payer. For example, if the credit account holder had provided a mobile phone number for the payer at box 603a, then the issuer payment service 216 could send a short message service (SMS) message to the client device 100 of the payer. As another example, if the credit account holder had provided an email address for the payer at box 603a, then the issuer payment service 216 could send an email to the email address for the payer.

However, in some implementations, the functionality of box 609a could be performed by the integrator service 256. For example, after creating a transaction identifier 266, the integrator service 256 could send the payment request message to the recipient. In these implementations, the issuer payment service 216 would have provided the integrator service 256 with the relevant contact information (e.g., phone number or email address) at box 606a.

The payment request message can include a number of items. For example, the payment request message could include a uniform resource indicator (URI) that includes an address for the integrator service 256 and the transaction identifier 266. The payment request message could further include a message or indication that the credit account holder is requesting funds from the payer, the amount of the funds, the identity of the credit account holder, etc.

Next at box 613a, the client application 276b can authenticate the payer and obtain from the payer an identification or selection of a monetary account identifier 249 from which the funds will be paid. For example, when the payer selects the link included in the payment request message, the client device 100 of the payer could open the client application 276b and direct the client application 276b to send a request to the integrator service 256. The request could include the transaction identifier 266 included in the URI that was previously sent at box 609a.

The integrator service 256 could then provide a response to the client application 276b to prompt the payer to identify his or her financial institution. This response could, for example, cause the client application 276b to render a user interface 106 to allow the payer to select the financial institution. After the payer selects the financial institution, the integrator service 256 could then prompt the client application 276b to obtain authentication credentials 233b from the payer.

After the payer supplies the authentication credentials 233b to the integrator service 256, the integrator service 256 could authenticate with the peer payment service 239 on behalf of the payer. Once authenticated, the integrator service 256 could then request a list of monetary account identifiers 249 from the peer payment service 239 that are associated with the payer. The integrator service 256 could then provide the list of monetary account identifiers 249 (e.g., account numbers for a checking account, a savings account, etc.) to the client application 276b for the payer to select an account from which the funds will be paid. Once the payer selects a monetary account identifier 249, the client application 276b can provide it to the integrator service 256. For example, if the payer selected his or her checking account from within the client application 276b, the client application 276b could provide the monetary account identifier 249 to the integrator service 256 as the selected account.

Proceeding to box 616a, the integrator service 256 can send the account identifier for the escrow account 223a of the respective issuer payment service 216, previously provided at box 606a, to the peer payment service 239. This can enable the peer payment service 239 to pay the requested funds on behalf of the payer from the previously identified monetary account to the credit issuer for the credit account holder.

Referring next to box 619a, the peer payment service 239c a transfer funds from the monetary account of the payer, as identified by the selected monetary account identifier 249, to the escrow account 223a identified at box 616. For example, the peer payment service 239 can initiate a transfer of funds to the escrow account 223a from the escrow account 223b associated with the peer institution that maintains the monetary account of the payer. For example, the peer payment service 239 could initiate an ACH payment from the escrow account 223b to the escrow account 223a. As another example, the peer payment service 239 could initiate a wire transfer payment from the escrow account 223b to the escrow account 223a. However, the peer payment service 239 can use any batch processed, net settlement or real time gross settlement payment system to transfer funds. In some implementations, the transaction identifier 266 may also be provided by the peer payment service 239 to the issuer payment service 216 to allow for the issuer payment service 216 to associate the deposit into the escrow account 223a with a specific transaction.

After the transfer of funds by the peer payment service 239, the peer payment service 239 and the issuer payment service 216 can adjust the respective account balances. For example, at box 623a, the issuer payment service 216 could apply a credit for the respective amount of funds transferred to the escrow account 223a to the outstanding balance of the credit account of the credit account holder. Similarly, at box 626a, the peer payment service 239 could debit or deduct from the monetary account of the payer a respective amount of funds. As a result, an individual who holds a credit account (e.g., a credit card account) is able to request and receive payment from monetary accounts of any individual. Moreover, the transaction can bypass existing credit card networks.

It should be noted that the functionality depicted at boxes 623a and 626a could be implemented earlier in the sequence diagram. For example, the respective credits and debits could occur prior to the transfer of funds at box 619a of the transfer of account information at box 616a.

Referring next to FIG. 6B, shown is a sequence diagram that provides an example of the operation of the interactions between the various components of the network environment 200 to request that one party pay funds from a monetary account to the credit account of another party. Accordingly, FIG. 6B can be viewed as an alternative example to the sequence diagram of FIG. 6A. It is understood that the sequence diagram of FIG. 6B provides merely an example of the many different types of functional arrangements that can be employed to implement a transfer of funds within the network environment 200. As an alternative, the sequence diagram of FIG. 6B can be viewed as depicting an example of elements of a method implemented within the network environment 200. Boxes 603b through 609b are similar to boxes 603a through 613b as previously described in FIG. 6A.

However, at box 616b, the integrator service 256 can provide information about the escrow account 223b of the peer payment service 239 to the issuer payment service 216. For example, during the authentication and account selection process that occurs at box 613b, the integrator service 256 could have also requested information about the escrow account 223b associated with the peer payment service 239. The integrator service 256 could then provide this data to the issuer payment service 216. However, these operations are optional, as sometimes the issuer payment service 216 may already know the relevant information for the escrow account 223b of the peer payment service 239. This could occur, for example, as a result of long-standing or pre-existing relationships between the issuer and peer financial institution.

Then at box 619b, in contrast to box 619a of FIG. 6A, the issuer payment service 216 could initiate a payment of funds from the escrow account 223b to the escrow account 223a. For example, the issuer payment service 216 could provide the account information for the escrow account 223b associated with the peer payment 239 to an intermediary (e.g., an automated clearinghouse or wire transfer service), which would then cause a payment or settlement to occur between the escrow accounts 223a and 223b for the amount of funds requested at box 603b.

The functionality depicted at boxes 623b and 626b are similar to that described with respect to boxes 623a and 626a, as previously described in FIG. 6A. Like boxes 623a and 626a, the functionality depicted at boxes 623b and 626b could be implemented earlier in the sequence diagram. For example, the respective credits and debits could occur prior to the transfer of funds at box 619b of the transfer of account information at box 616b.

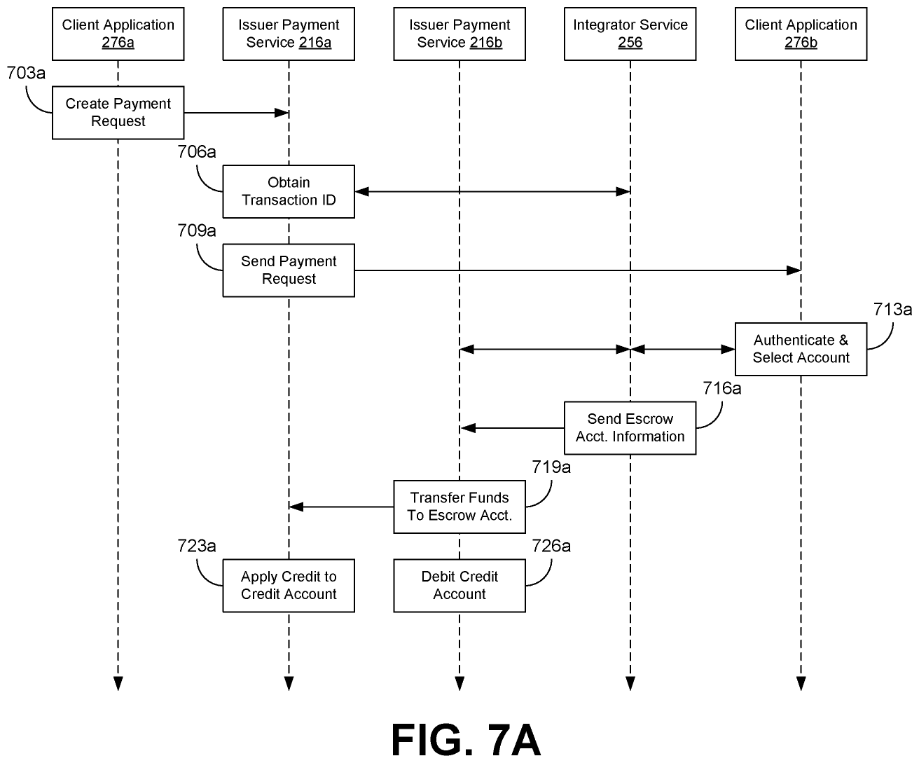

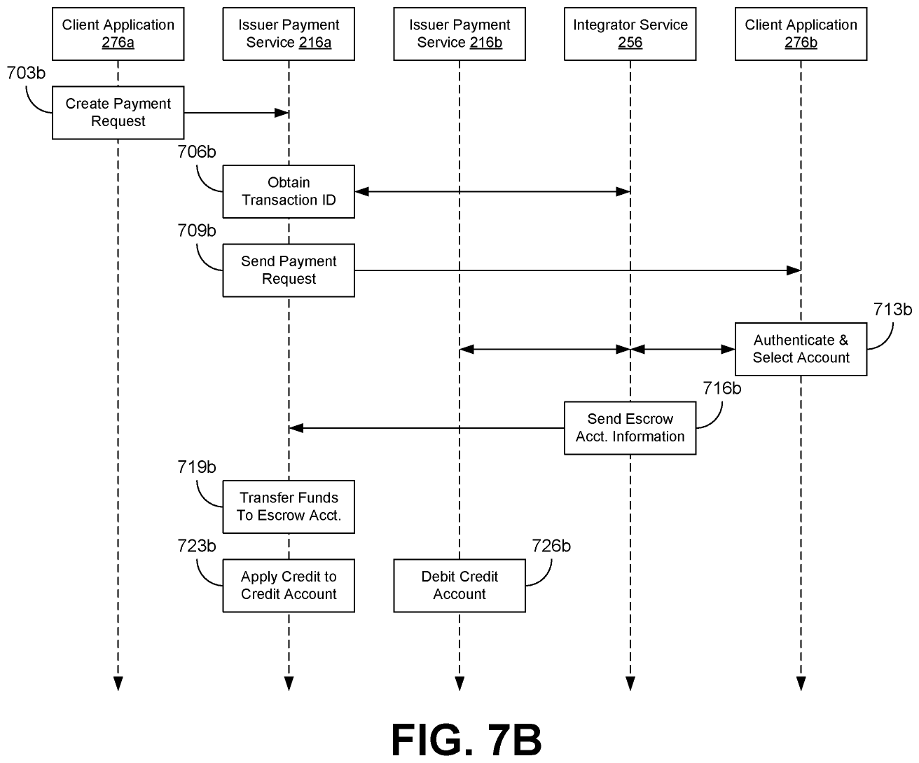

Referring next to FIG. 7A, shown is a sequence diagram that provides one example of the operation of the interactions between the various components of the network environment 200 request that one party pay funds from a credit account to the credit account of another party. It is understood that the sequence diagram of FIG. 7A provides merely an example of the many different types of functional arrangements that can be employed to implement a transfer of funds between the credit card issuer and the peer financial institution within the network environment 200. As an alternative, the sequence diagram of FIG. 7A can be viewed as depicting an example of elements of a method implemented within the network environment 200.

Beginning with box 703a, a payment request can be created by the client application 276a and forwarded to the issuer payment service 216a. The payment request could be created by a recipient interacting with a user interface 106 rendered by the client application 276a. For instance, a credit account holder (e.g., a credit card holder) could create a request that a credit account holder at another issuer pay the credit account holder a specified sum of funds, which could be applied as a credit to the outstanding balance of the respective credit account. The request could include the amount of funds requested, the identity of the payer, and the contact information of the payer. Once complete, the payment request can be forwarded on to the issuer payment service 216a.

In some implementations, multiple payment requests could be created at box 703a. For example, a recipient could select a transaction displayed within a user interface 106 of the client application 276a and indicate that he or she wishes to split the transaction between multiple individuals. This could occur, for example, if the recipient made a purchase on behalf of a group of individuals and wished to be reimbursed. In this example, the cost of the transaction could be split between individual payers, as indicated by the recipient, and a respective payment request could be created for each individual payer that owed funds to the recipient.

Then at box 706a, the issuer payment service 216a can send a request to the integrator service 256 for a transaction identifier 266. In response, the integrator service 256 can generate and provide the transaction identifier 266 to the issuer payment service 216a. The issuer payment service 216a may store the transaction identifier 266 temporarily in order to allow the issuer payment service 216a to later determine or map the request to pay funds from the credit account of the payer to the credit account of the recipient. In some instances, the issuer payment service 216a can provide the integrator service 256 with the account number for the escrow account 223a associated with the issuer payment service 216.

Moving on to box 709a, the issuer payment service 216a can send a payment request message to the requested payer. For example, if the credit account holder had provided a mobile phone number for the payer at box 703a, then the issuer payment service 216a could send a short message service (SMS) message to the client device 100 of the payer. As another example, if the credit account holder had provided an email address for the payer at box 703a, then the issuer payment service 216a could send an email to the email address for the payer.

However, in some implementations, the functionality of box 709a could be performed by the integrator service 256. For example, after creating a transaction identifier 266, the integrator service 256 could send the payment request message to the recipient. In these implementations, the issuer payment service 216 would have provided the integrator service 256 with the relevant contact information (e.g., phone number or email address) at box 706a.

The payment request message can include a number of items. For example, the payment request message could include a uniform resource indicator (URI) that includes an address for the integrator service 256 and the transaction identifier 266. The payment request message could further include a message or indication that the credit account holder is requesting funds from the payer, the amount of the funds, the identity of the credit account holder, etc.

Next at box 713a, the client application 276b can authenticate the payer and obtain from the payer an identification or selection of a credit account identifier 236 from which the funds will be paid. For example, when the payer selects the link included in the payment request message, the client device 100 of the payer could open the client application 276b and direct the client application 276b to send a request to the integrator service 256. The request could include the transaction identifier 266 included in the URI that was previously sent at box 709a.

The integrator service 256 could then provide a response to the client application 276b to prompt the payer to identify his or her financial institution. This response could, for example, cause the client application 276b to render a user interface 106 to allow the payer to select the financial institution. After the payer selects the financial institution, the integrator service 256 could then prompt the client application 276b to obtain authentication credentials 233a from the payer.

After the payer supplies the authentication credentials 233a to the integrator service 256, the integrator service 256 could authenticate with the issuer payment service 216b on behalf of the payer. Once authenticated, the integrator service 256 could then request a list of credit account identifiers 236 from the issuer payment service 216b that are associated with the payer. The integrator service 256 could then provide the list of credit account identifiers 236 (e.g., account numbers for a checking account, a savings account, etc.) to the client application 276b for the payer to select an account from which the funds will be paid. Once the payer selects a credit account identifier 236, the client application 276b can provide it to the integrator service 256. For example, if the payer selected his or her checking account from within the client application 276b, the client application 276b could provide the credit account identifier 236 to the integrator service 256 as the selected account.

Proceeding to box 716a, the integrator service 256 can send the account identifier for the escrow account 223a of the respective issuer payment service 216, previously provided at box 706a, to the issuer payment service 216b. This can enable the issuer payment service 216b to pay the requested funds on behalf of the payer from the previously identified credit account to the credit issuer for the credit account holder.

Referring next to box 719a, the issuer payment service 216b c a transfer funds from the escrow account 223a associated with the issuer payment service 216b to the escrow account 223a identified at box 716a. While an issuer payment service 216 is illustrated previously in FIG. 2 as having an escrow account 223a, where two separate issuer payment services 216a and 216b are exchanging funds, each issuer payment service 216 is understood to have a separate escrow account 223a. For example, the issuer payment service 216b could initiate an ACH between the escrow accounts 223a. As another example, the issuer payment service 216b could initiate a wire transfer between the escrow accounts 223a. However, the issuer payment service 216b can use any batch processed, net settlement or real time gross settlement payment system to transfer funds. In some implementations, the transaction identifier 266 may also be provided by the issuer payment service 216b to the issuer payment service 216a to allow for the issuer payment service 216a to associate the deposit into the escrow account 223a with a specific transaction. However, in alternative implementations, the issuer payment service 216a could also cause a transfer of funds to occur between the two escrow accounts 223a.

After the transfer of funds by the issuer payment service 216b, the issuer payment service 216b and the issuer payment service 216a can adjust the respective account balances. For example, at box 723a, the issuer payment service 216a could apply a credit for the respective amount of funds transferred to the escrow account 223a to the outstanding balance of the credit account of the credit account holder. Similarly, at box 726a, the issuer payment service 216b could debit or deduct from the monetary account of the payer a respective amount of funds. As a result, individuals with credit accounts (e.g., a credit card accounts) are able to request and receive payment from credit accounts of any other individual. Moreover, the transaction can bypass existing credit card networks.

Referring next to FIG. 7B, shown is a sequence diagram that provides one example of the operation of the interactions between the various components of the network environment 200 request that one party pay funds from a credit account to the credit account of another party. Accordingly, FIG. 7B can be viewed as an alternative example to the sequence diagram of FIG. 7A. It is understood that the sequence diagram of FIG. 7B provides merely an example of the many different types of functional arrangements that can be employed to implement a transfer of funds between the credit card issuer and the peer financial institution within the network environment 200. As an alternative, the sequence diagram of FIG. 7B can be viewed as depicting an example of elements of a method implemented within the network environment 200. Boxes 703b through 709b are similar to boxes 703a through 713b as previously described in FIG. 6A.

However, at box 716b, the integrator service 256 can provide information about the escrow account 223a of the issuer payment service 216b to the issuer payment service 216a. For example, during the authentication and account selection process that occurs at box 713b, the integrator service 256 could have also requested information about the escrow account 223a associated with the issuer payment service 216b. The integrator service 256 could then provide this data to the issuer payment service 216a. However, these operations are optional, as sometimes the issuer payment service 216a may already know the relevant information for the escrow account 223a of the issuer payment service 216b. This could occur, for example, as a result of long-standing or pre-existing relationships between the issuers.

Then at box 719b, in contrast to box 719a of FIG. 7B, the issuer payment service 216a could initiate a payment of funds from the escrow account 223a of the issuer payment service 216b to the escrow account 223a of the issuer payment service 216a. While an issuer payment service 216 is illustrated previously in FIG. 2 as having an escrow account 223a, where two separate issuer payment services 216a and 216b are exchanging funds, each issuer payment service 216 is understood to have a separate escrow account 223a. For example, the issuer payment service 216 could provide the account information for the escrow account 223a associated with the issuer payment service 216b to an intermediary (e.g., an automated clearinghouse or wire transfer service), which would then cause a payment or settlement to occur between the escrow accounts 223a for the amount of funds requested at box 703b.

The functionality depicted at boxes 723b and 726b are similar to that described with respect to boxes 723a and 726a, as previously described in FIG. 7A. Like boxes 723a and 726a, the functionality depicted at boxes 723b and 726b could be implemented earlier in the sequence diagram. For example, the respective credits and debits could occur prior to the transfer of funds at box 719b of the transfer of account information at box 716b.

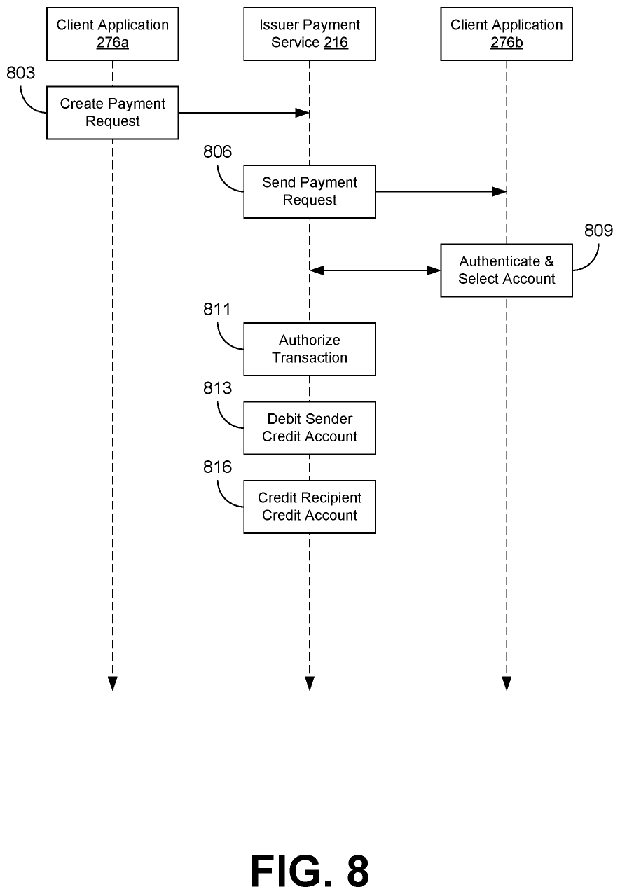

Referring next to FIG. 8, shown is a sequence diagram that provides one example of the operation of the interactions between the various components of the network environment 200 to transfer funds between credit accounts (e.g., credit cards) issued by the same institution. It is understood that the sequence diagram of FIG. 8 provides merely an example of the many different types of functional arrangements that can be employed to implement a transfer of funds within the network environment 200. As an alternative, the sequence diagram of FIG. 8 can be viewed as depicting an example of elements of a method implemented within the network environment 200.

Beginning with box 803, a payment request can be created by the client application 276a and forwarded to the issuer payment service 216. The payment request could be created by a recipient interacting with a user interface 106 rendered by the client application 276a. For instance, a credit account holder (e.g., a credit card holder) could create a request that another credit account holder at the same institution pay a specified sum of funds, which could be applied as a credit to the outstanding balance of the respective credit account. The request could include the amount of funds requested, the identity of the payer, and the contact information of the payer. Once complete, the payment request can be forwarded on to the issuer payment service 216.

In some implementations, multiple payment requests could be created at step 803. For example, a recipient could select a transaction displayed within a user interface 106 of the client application 276a and indicate that he or she wishes to split the transaction between multiple individuals. This could occur, for example, if the recipient made a purchase on behalf of a group of individuals and wished to be reimbursed. In this example, the cost of the transaction could be split between individuals, as indicated by the recipient, and a respective payment request could be created for each individual payer that owed funds to the recipient.

Next at box 806, the issuer payment service 216 can send a payment request message to the payer. For example, if the requestor had provided a mobile phone number for the recipient at box 803, then the issuer payment service 216 could send a short message service (SMS) message to the client device 100 of the payer. As another example, if the requestor had provided an email address for the payer at box 803, then the issuer payment service 216 could send an email to the email address for the payer. The message could include, for example a link to an authentication page provided by the issuer payment service 216.

Then at box 809, the client application 276b can authenticate with the issuer payment service 216. For example, the payer could input authentication credentials 233a into a user interface 106 of the client application 276b, which the client application 276b could use to authenticate the payer with the issuer payment service 216. In response to authentication, the issuer payment service 216 could provide the client application 276b with one or more credit account identifiers 236 from which the payer could select (e.g., credit card account numbers of credit card accounts held by the recipient with the issuer). The credit account identifiers 236 could then be presented to the payer in a user interface 106 by the client application 276b, who could select an account from which funds would be paid. The selected credit account identifier 236 could then be provided to the issuer payment service 216.

Moving on to box 811, the issuer payment service 216 can authorize the transaction. For example, the issuer payment service 216 could evaluate whether a credit limit associated with the credit account identifier 236 has a sufficient amount of credit to permit a payment of the funds to the recipient. If the issuer payment service 216 fails to authorize the transaction, the sequence of interactions may stop.

At boxes 813 and 816, the account balances of the credit accounts of the payer and requestor could be adjusted to reflect the transaction. For example, at box 13, the credit account of the payer could be debited by the issuer payment service 216 to reflect the payment of funds. Likewise, at box 816, the credit account of the requestor could be credited by a respective amount of funds to reflect the payment. As a result, two credit account holders are able to pay funds to or receive funds from any other credit account holder at the same institution without having to use a credit card transaction network.

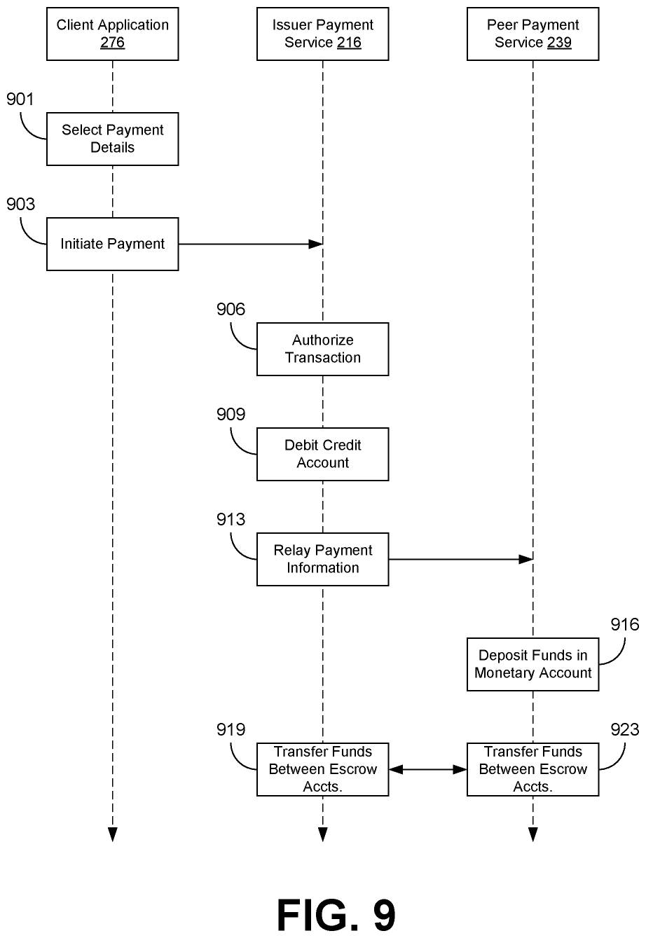

Referring next to FIG. 9, shown is a sequence diagram that provides one example of the operation of the interactions between the various components of the network environment 200 to transfer funds between a credit card issuer and a peer financial institution. It is understood that the sequence diagram of FIG. 9 provides merely an example of the many different types of functional arrangements that can be employed to implement a transfer of funds within the network environment 200. As an alternative, the sequence diagram of FIG. 9 can be viewed as depicting an example of elements of a method implemented within the network environment 200.

Beginning with box 901, a payer can interact with the client application 276 can select details related to creating a payment for a recipient. For example, the payer using the client application 276 could select a recipient from a list of recipients presented in a user interface 106 of the client device 100. By selecting a recipient, the payer could also select a unique identifier for the recipient (e.g., a phone number, email address, or other identifier). The payer could also specify the amount of funds to pay the recipient. In some instances, the payer could also specify a credit account identifier 236 for a credit account to be used for the payment (e.g., if a payer had multiple credit or charge card accounts).

Then at box 903, the client application 276 can initiate payment to the recipient. For example, the client application 276 could provide the identifier of the recipient to the issuer payment service 216, the amount of funds to be paid, and the credit account identifier 236.

Next at box 906, the issuer payment service 216 can authorize the transaction. For example, the issuer payment service 216 could evaluate whether a credit limit associated with the credit account identifier 236 has a sufficient amount of credit to permit a payment of the funds to the recipient. If the issuer payment service 216 fails to authorize the transaction, the sequence of interactions may stop.

Moving on to box 909, the issuer payment service 216 could debit the credit account of the user for the amount of funds to be paid to the recipient. For example, the issuer payment service 216 could reduce the credit limit associated with the credit account identified by the credit account identifier 236. It should be noted, however, this operation could be performed later in the sequence diagram.

Subsequently at box 913, the issuer payment service 216 can relay information about the payment to the peer payment service 239. The issuer payment service 216 can identify the appropriate peer payment service 239 in several ways. For example, the peer payment service 239 could have been specified by the payer at box 901. Alternatively, the issuer payment service 216 may have a record in the payee directory 221a for the recipient, which indicates which peer payment service 239 to interact with when transferring funds to the recipient based on a previous transaction.

Then at box 916, the peer payment service 239 can deposit or credit a corresponding amount of funds to a monetary account associated with the recipient. For example, if the recipient has a single monetary account registered for the recipient, the peer payment service 239 could apply a deposit or credit to that account. If the recipient has multiple monetary accounts, then the funds could be credited or deposited to a default one specified by the recipient.

Next at boxes 919 and 923, the funds are eventually transferred between the escrow accounts 223a and 223b associated with the issuer payment service 216 and the peer payment service 239. This could be as a part of a batch processed net settlement process that occurs at periodic intervals (e.g., nightly, weekly, hourly, etc.). For example, the peer payment service 239 could initiate a request to pull funds from the escrow account 223a of the issuer payment service 216. As another example, the issuer payment service 216 could initiate a request to push or send funds to the escrow account 223b of the peer payment service 239.

Although the sequence diagram depicted in FIG. 9 illustrates an example of a process for transferring funds between a credit account maintained by an issuer and a monetary account maintained by a peer payment service 239, it should be noted that a substantially similar process could be used for transferring funds between credit accounts maintained by two separate issuers. However, instead of depositing funds into a monetary account at box 916, a credit would be applied to credit account of the recipient.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code or machine-readable instructions in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a first computing device comprising a processor and a memory; and
machine-readable instructions stored in the memory that, when executed by the processor, cause the first computing device to at least:
receive a message from a second computing device, the message comprising a notification of a funds transfer and a transaction identifier linked to the funds transfer; and
send a request to process the funds transfer to a third computing device, the request comprising the transaction identifier for the funds transfer, an account identifier and an institution identifier.

2. The system of claim 1, wherein the machine-readable instructions stored in the memory that, when executed by the processor, cause the first computing device to at least:
receive an indication that the funds transfer is complete; and
render, on a display of the first computing device, the indication that the funds transfer is complete.

3. The system of claim 1, wherein the transaction identifier is included within a uniform resource indicator (URI) that is included in the message, and the machine-readable instructions, when executed by the processor, further cause the first computing device to at least:
send a first request addressed to the URI;
receive a list of institutions in response to the first request;
in response to a selection of an institution from the list of institutions, receive a second request for authentication credentials for the institution; and
in response to submission of the authentication credentials, receive a list of monetary accounts maintained by the institution selected from the list of institutions.

4. The system of claim 3, wherein the first computing device comprises a display and the machine-readable instructions, when executed by the processor, further cause the first computing device to at least:
present, within a user interface rendered by the display, the list of monetary accounts;
in response to selection of a monetary account from the list of monetary accounts, include the account identifier for the monetary account in the request to process the funds transfer.

5. The system of claim 1, wherein the machine-readable instructions further cause the first computing device to at least:
render, within a user interface presented on a display of the first computing device, a prompt to confirm the funds transfer; and
the request to process the funds transfer is sent in response to a confirmation of the funds transfer.

6. The system of claim 1, wherein the message is a short message service (SMS) message.

7. A method, comprising:
receiving, from a first client device, a request to send a specified amount of funds from a specified credit account to a recipient;
requesting, from a computing device, a transaction identifier for the request to send the specified amount of funds to the recipient;
sending a first notification to a second client device, wherein the first notification comprises the transaction identifier and the second client device is associated with the recipient;
receiving, from the computing device, a second notification that the recipient has accepted the specified amount of funds, wherein the second notification identifies a monetary account; and
initiating a funds transfer to the monetary account for the specified amount of funds.

8. The method of claim 7, further comprising debiting the specified amount of funds from the specified credit account.

9. The method of claim 7, wherein initiating the funds transfer to the monetary account for the specified amount of funds further comprises initiating a payment through a real-time gross settlement (RTGS) system.

10. The method of claim 7, wherein initiating the funds transfer to the monetary account for the specified amount of funds further comprises initiating a payment through a batch processed, net settlement network.

11. The method of claim 7, wherein initiating the funds transfer to the monetary account for the specified amount of funds further comprises initiating a payment from an escrow account to the monetary account for the specified amount of funds.

12. The method of claim 7, wherein:
the request to send the specified amount of funds from the specified credit account to the recipient further comprises contact information for the recipient; and
wherein sending the first notification to the second client device further comprises sending the first notification to a destination specified in the contact information.

13. The method of claim 7, further comprising:
creating a uniform resource indicator (URI) that includes the transaction identifier; and
including the URI in the first notification.

14. The method of claim 7, wherein the second notification further comprises the transaction identifier.

15. The method of claim 7, further comprising sending a message to the first client device, the message indicating that the recipient has accepted the specified amount of funds.

16. A non-transitory computer-readable medium, comprising machine-readable instructions that, when executed by a processor of a first computing device, cause the first computing device to at least:
receive a request to process a funds transfer from a client device, the request comprising a transaction identifier;
provide a list of institutions to the client device;
receive, from the client device, a first selection of an institution from the list of institutions;
request, from the client device, authentication credentials for the institution selected from the list of institutions;
in response to receipt of the authentication credentials, provide the client device with a list of accounts associated with the institution selected from the list of institutions;
receive a second selection of an account from the list of accounts; and
provide, to a second computing device, the transaction identifier, a first identifier for the institution selected from the list of institutions, and a second identifier for the account selected from the list of accounts.

17. The non-transitory, computer-readable medium of claim 16, wherein the request to process the funds transfer is a second request, and the machine-readable instructions, when executed by the processor, cause the first computing device to:
generate the transaction identifier in response to a first request from the second computing device for the transaction identifier; and
provide the transaction identifier to the second computing device.

18. The non-transitory, computer-readable medium of claim 16, wherein the transaction identifier is included within a uniform resource identifier (URI) requested by the client device in the request to process the funds transfer.

19. The non-transitory, computer-readable medium of claim 16, wherein the machine-readable instructions, when executed by the processor, further cause the first computing device to at least authenticate with a peer payment service operated by the institution selected from the list of institutions on behalf of the client device using the authentication credentials.

20. The non-transitory, computer-readable medium of claim 16, wherein the machine-readable instructions, when executed by the processor, further cause the first computing device to at least provide a third identifier to the second computing device for an escrow account associated with the funds transfer.
